(19) United States
(12) Patent Application Publication
(10) Pub. No.: US 2023/0417713 A1
(43) Pub. Date: Dec. 28, 2023

(54) ANALYTICAL APPARATUS

(71) Applicant: SPECTRA ANALYSIS INSTRUMENTS, INC., Marlborough, MA (US)

(72) Inventors: Umberto SAINI FASANOTTI, Breganzona (CH); Luigi MONDELLO, Messina (IT); Paola Agata Eustochia DONATO, Barcellona Pozzo di Gotto (ME) (IT); Tania Maria Grazia SALERNO, Palagonia (CT) (IT)

(73) Assignee: SPECTRA ANALYSIS INSTRUMENTS, INC., Marlborough (US)

(21) Appl. No.: 18/033,046

(22) PCT Filed: Oct. 29, 2021
(86) PCT No.: PCT/IB2021/060032

§ 371 Date: Apr. 20, 2023

(30) Foreign Application Priority Data
Oct. 30, 2020 (IT) 102020000025909

(51) Int. Cl. G01N 30/78; G01N 30/72; G01N 30/74; G01N 30/86

(52) U.S. Cl. CPC G01N 30/78; G01N 30/72; G01N 2030/743; G01N 30/8675; G01N 30/74

(57) ABSTRACT

An apparatus chemical analysis of a sample includes:
a chromatographic module configured to separate compounds that make up a mixture to be analyzed and which is configured to determine a linear retention index of the separated compounds;
a module for mass spectrometry, configured to detect and/or determine mass spectra of the separated compounds, from the chromatographic module;
a module for IR spectroscopy, configured to detect and/or determine the IR spectra of the separated compounds, from said chromatographic module;
at least one processing unit configured to receive data, acquired by the chromatographic module; the module for mass spectrometry; and the module for IR spectroscopy; and
at least one memory unit associated with the at least one processing unit, having at least one organized file containing the retention indices, the mass and IR spectra of a plurality of known and predefined compounds.

### TECHNICAL FIELD

The present invention relates to an improved analytical apparatus for the chemical analysis of a sample and, in particular, for the identification of the chemical compounds contained in a mixture of a sample to be analyzed. More in detail, the present invention relates to an apparatus for identifying the compounds present within an unknown mixture to be analyzed.

### BACKGROUND OF THE INVENTION

Methods for the analysis of mixtures are known which allow to identify the presence of specific compounds within a mixture of an unknown sample, or to describe new compounds.

The use of chemical or physico-chemical investigation techniques is known to determine which compounds are contained within an unknown sample.

Chromatographic techniques represent one of the most versatile and widespread means for modern chemical analyses, thanks to the high separation capacities and the possible coupling with the most diverse detection methods. In particular, it is known the possibility of obtaining the separation of components of complex mixtures for qualitative and/or quantitative purposes by means of gas chromatography (GC) for volatile or gaseous molecules, high performance liquid chromatography (HPLC) and thin layer chromatography (TLC) for non-volatile and/or high molecular weight molecules, supercritical (SFC) or subcritical (sub-SFC) fluid chromatography with characteristics similar to GC and HPLC. Similarly, the separation of molecules that differ in their net charge can occur by capillary electrophoresis (EC).

In particular, the known chromatographic techniques allow to separate the various compounds contained in a mixture. More in detail, the chromatographic technique involves the injection of a sample containing a mixture of one or more unknown compounds into a chromatographic system, and its passage through a chromatographic column inside which a stationary phase is present. Subsequently, a mobile phase is passed which tends to drag (elute) the compounds that had been retained inside the column. Based on the different affinity of the compounds present in the mixture to be analyzed with the stationary phase, the same compounds will leave the chromatographic column at different times (retention times).

Mass spectrometry is also known, which is a technique that involves measuring the molecular mass of molecules, even those present in a mixture. This technique generally involves ionizing the molecules to be analyzed and subsequently separating them based on their mass/charge (m/z) ratio, generally by applying static or oscillating magnetic fields. The instability of the ionized molecules also causes them to fragment, giving rise to smaller ions with different m/z ratios, based on their chemical structure. Obviously in the case of isomeric compounds, characterized by identical values m/z, the relative discrimination by mass spectrometry is, at least in the first instance, precluded. If the analyzed sample contains more than one chemical compound, it is very difficult to interpret the resulting mass spectrum, which will obviously be the result of the contributions of the individual molecules that constitute it.

The coupling of chromatography with mass spectrometry is also known, in order to obtain the mass spectrum attributable to each single chemical compound among those that make up a mixture to be analyzed, and this thanks to the previous separation of the chemical compounds present in the sample carried out by chromatography. This solution also provides information that may not be sufficient for the univocal and reliable identification of the chemical compounds present in the mixture of a sample to be analyzed.

The coupling of gas chromatographic separation techniques with mass spectrometer (MS) detection provides a powerful and versatile analytical platform (GC-MS), today used in various fields of application, including food, cosmetics, environmental, petrochemical, forensics. GC-MS techniques offer high performance in the separation of complex mixtures of volatile compounds, through the use of high efficiency capillary columns; the simplest configurations consist in coupling to a single quadrupole MS detector by means of an electron impact (EI) source. Against the moderate costs for the purchase and maintenance, this type of instrumentation offers considerable sensitivity (in the order of femtograms) and selectivity for the identification and quantitative determination, in “target” approaches, aimed at determining known compounds of interest, or “untargeted”, for screening the constitutive profile of matrices. Inherent robustness and reproducibility of the technique, as well as the wide commercial availability of instrumentation and spectral libraries have contributed to the widespread use of GC-MS for the identification of unknown compounds and/or metabolites.

On the other hand, there are clear limitations to the identification capabilities of GC-MS techniques, in the case of compounds with identical elemental composition (and therefore identical mass/charge ratios, ) and which also show a very similar or identical fragmentation for EI and, in general, in the case of very similar molecules for chemical structure and/or fragmentation. Provided that these structural isomers and diastereomers, or molecules related by fragmentation, are chromatographically resolved, it is not possible to obtain the univocal discrimination, on the basis of the retention times alone. In the absence of adequate reference substances (standards), the molecular recognition of these compounds will therefore be subject to the use of a further analytical technique, which involves the isolation of the molecules of interest, or their synthesis, followed by a process of purification/concentration, prior to further characterization using complementary techniques (e.g. nuclear magnetic resonance, NMR).

Similar limitations exist for the liquid counterpart, as HPLC-MS techniques are widely used for the analysis of non-volatile molecules in various fields of research and applications, in the food, cosmetic, environmental, pharmaceutical, toxicological, forensic fields, etc. The ionization sources commonly used are of the “soft” type, in particular electrospray ionization (ESI) and chemical ionization at atmospheric pressure (APCI), coupled to single (q-MS) or triple quadrupole (QqQ-MS) analyzers, time of flight (ToF), ion trap (IT-MS) etc. The use of particular fluids, commonly carbon dioxide, in supercritical or subcritical conditions, in substitution (partial or total) of the organic mobile phase makes SFC techniques particularly advantageous in terms of selectivity, environmental impact, analysis time. Reduced analysis times and limited sample volumes are also advantageous features of electrophoretic techniques, traditionally used mainly in proteomics and genomics. The coupling of the above mentioned techniques with the MS detection undoubtedly provides a very powerful tool for identification purposes, but with all the limitations already highlighted for the GC counterpart.

The use of spectroscopy or spectrophotometry is also known. These techniques provide for the irradiation of the sample to be analyzed with electromagnetic radiation of a suitable wavelength, in order to measure its absorption or emission at specific wavelengths, so as to obtain information on the molecules present within the compound and on the respective chemical bonds. In particular, infrared (IR) spectroscopy is very useful for identification purposes, since each compound has a series of absorption peaks at specific wavelengths and intensities (the so-called “fingerprint”) and, therefore, it is theoretically possible, starting from the spectrum, to go back to the corresponding molecule that generated it. In particular, when the sample is irradiated with wavelengths in the infrared region, information can be obtained that makes it possible to distinguish between structural isomers and diastereomers. The absorption spectra are often very complex to interpret, especially if the sample to be analyzed contains a mixture of a plurality of compounds and, therefore, it has already been proposed to separate the compounds of the mixture by means of a chromatographic technique, to then analyze the individual compounds separated by IR spectroscopy.

In particular, Fourier Transform Infrared Spectroscopy (FTIR), based on distinct chemical properties of the analytes, provides information complementary to those of mass spectrometry and moreover, measuring small differences in the energy of the rotational and vibrational motions between the different molecular bonds, it allows to overcome the intrinsic limitations to MS detection, for the discrimination of structural isomers and diastereomers and in general of very similar molecules for chemical structure and/or fragmentation. Furthermore, detection by FTIR is not conditioned by the need for adequate ionization of the analytes in a source, as in GC-MS or HPLC-MS techniques, so no disparities in detection such as those resulting from matrix effects or different ranges of concentration of the constituents of the sample (ion suppression).

From an instrumental point of view, the development of the GC-FTIR and HPLC-FTIR techniques was however very slow and discontinuous compared to the MS counterpart, which can now be considered a mature and constantly evolving technique. In particular, the first attempts to interface a gas chromatograph to an IR detector date back to the 1960s, but received considerable momentum only after the replacement of the old dispersive elements (prisms, gratings) with the interferometer and the use of mathematical operators based on on the Fourier transform. The first GC-FTIR systems could count on the speed of non-dispersive IR instruments, but provided for the use of “megabore” GC columns characterized by poor efficiency, and above all they were operated in “stopped-flow” mode, with the associated negative consequences in terms of analysis time and artifacts deriving from the manipulation of the sample.

The interface most commonly used in GC-FTIR techniques consists of a flow cell (light pipe, LP) enclosed between two IR transparent windows, the ends of which are connected to the GC column (inlet) and to an IR detector (outlet). In this way, the acquisition of the spectra of the components eluted by the GC system occurs in the gas phase, with the addition of an auxiliary gas flow (make-up) to compensate for the larger diameter of the flow cell compared to that of the GC column (typically, 1.5 vs. 0.32 mm i.d.). This allows to preserve the chromatographic resolution, however at the expense of an increased residence time of the analytes in the interface and, therefore, of a loss in sensitivity, also worsened by the high temperatures required for the less volatile compounds and the generation of background noise in the resulting IR spectrum. This GC-FTIR coupling requires a compromise in terms of sensitivity and speed, to a greater extent in the case of capillary columns used today (typically, 0.25 mm i.d.). On the one hand, the small peak amplitudes require adequate sampling rates for the acquisition of representative IR spectra, on the other hand the lower sensitivity of the IR detector requires sample quantities that are not always compatible with the reduced load capacities of capillary GC columns.

Other types of GC-FTIR interfaces were developed later, in an attempt to obtain lower detection limits (LODs) than those typical of light pipes: the so-called “sample trapping” techniques, such as the “matrix isolation” (ME) technique. However, even this procedure is not fully satisfactory as it is based on cryogenic devices for the elimination of the mobile phase by trapping the separated compounds at very low temperatures, up to 11 K; in addition, a high vacuum and a sealed housing for the interface are required to avoid interference from carbon dioxide and water vapor from the surrounding environment, thus making the procedure as a whole complex and laborious. Furthermore, in order to facilitate the freezing of the analytes, in this technique an auxiliary flow of argon (1-2%) mixed with the carrier gas is used.

Quite similar considerations are valid for HPLC and FTIR coupling (and in general, for all separation techniques that use solvents in the mobile phase), with the further obvious requirement of an interface for the elimination of the solvent (mobile phase) exiting from the HPLC column and before deposition of the analytes on the IR disk. A fully automated and versatile version of this interface uses a “Multi-step desolvation” process to obtain the desolvation of the liquid chromatographic effluent, while preserving the temporal resolution of the analytes dissolved in it, through the sequential use of a nebulizer, a cyclonic evaporator and a double condensation stage. The HPLC-FTIR system thus interfaced allows wide versatility in use, being compatible with all the most common solvents and additives used as mobile phase for the chromatographic separation process, as well as operable at conventional mobile phase flows.

Currently, the main approach to the identification of an unknown compound from its mass spectrum is the search for commercial libraries, containing the mass spectra obtained from pure standard, applying a minimum similarity criterion to abut against a list of compounds whose spectrum is similar or very similar to that of the target analyte. However, this process of identifying unknown compounds by searching in spectral databases is not entirely reliable. First of all, the library search will suggest as a result different chemical structures for a given spectrum, sometimes of compounds with very similar purity levels; the possibility of contradictory results obtained through different libraries should also be taken into consideration. Several factors can contribute to making a poorly reliable library, such as inaccurate experimental conditions; this is especially the case of libraries containing spectra coming from the literature or acquired with different instrumentation. The spectral differences can be considerable, depending on whether a magnetic or quadrupole analyzer or an ion trap is used for the acquisition. The same compound can also give rise to different spectra, not due to the different experimental conditions but due to an incorrect sampling or interpretation of the data; finally, there is the possibility that the spectra of a given compound have been recorded more than once, with different names (systematic or common) or different CAS (Chemical Abstracts Service) identifiers.

The difficulties increase proportionally in the analysis of complex mixtures, the components of which have very similar chemical structures and, consequently, the corresponding mass spectra will also be very similar. A typical example in the field of volatile compounds is represented by essential oils, consisting of mixtures of monoterpenic and sesquiterpenic hydrocarbons, together with their oxygenated derivatives and oxygenated aliphatic compounds. Even the analysis of the non-volatile fraction of vegetable oils can prove difficult, given the complex composition and the presence of compounds which are very similar in structure and MS fragmentation, for example bioactive molecules such as polyphenols present in numerous forms of aglycones and glycosides. The identification of the components of these extremely complex mixtures is difficult and the data reported in the literature are sometimes in contradiction with each other. Many of these molecules in fact have almost identical mass spectra, due to the similarity of the initial chemical structures, or as a result of the fragmentation and rearrangement processes that the molecules undergo after ionization in the MS source. Identification by MS should therefore always be accompanied by additional information to support the results obtained.

The article “Evaluation of gas chromatography-Fourier transform infrared spectroscopy-mass spectrometry for analysis of phenolic compounds” shows an apparatus for the analysis of phenolic compounds that includes a gas chromatograph that separates the molecules present inside the sample and submits them to a first detector based on infrared spectroscopy, and subsequently to a mass spectrometer positioned in series. However, this solution is not fully satisfactory as the positioning of the IR spectrophotometer between the gas chromatograph and the mass spectrometer prevents the use of techniques such as sample trapping infrared spectroscopy, or other destructive techniques of the sample. In this case, the IR detection takes place inside a flow cell (light pipe), with negative repercussions in terms of resolution and sensitivity, deriving from the fact that the IR spectra are acquired by the analytes in the gas phase, with the associated distortions and broadening of the spectral bands, as well as mixing of the analytes separated from the column and loss of chromatographic resolution. Furthermore, the arrangement in series of the IR and MS detectors necessarily requires a compromise in terms of sensitivity and speed of acquisition (sampling frequency) and dynamic range of the two detectors. In particular, since the IR technique is characterized by a considerably lower sensitivity than the MS technique, two conditions necessarily occur in the case of series configuration of the two detectors. The first is that the quantity of flow coming out of the separation column or the quantity of analyte is adequate to obtain an informative MS spectrum, but insufficient for the acquisition of an IR spectrum. To overcome this drawback, the second possibility consists in the injection of an excess quantity of mixture (analyte) causing an overload and potential saturation of the separation column and consequent worsening of the chromatographic resolution. In this way it would be possible to compensate for the low sensitivity of the IR detector, but the quality of the MS spectrum would be deteriorated due to the excessive collision of the analyte molecules in the ionization phase and the production of additional and irrelevant m/z signals; in addition, some parts of the MS spectrometer may be contaminated and therefore require more frequent maintenance. Finally, the identification of compounds using this apparatus is based (also) on the analysis of retention times, which are notoriously unstable as they are subject to even considerable variations in relation to the type of stationary phase and to the method used for separation (temperature conditions, flow); this makes the whole method not very reproducible.

US 2019/0324003 shows an apparatus for the analysis of organic compounds that includes a gas chromatograph that separates the molecules present in the sample and sends them to a spectrophotometer operating in the ultraviolet (UV) and to a mass spectrometer positioned in parallel or in series compared to the UV spectrophotometer. However, this solution is not fully satisfactory as the information obtained by UV spectroscopy does not allow to draw detailed conclusions about the structure and therefore the identity of a specific molecule, since the absorptions are substantially influenced by the electronic properties of the molecules themselves and referable to functional groups (chromophores) potentially shared by completely different molecules. Furthermore, the system used for splitting the flow out of the column is not easily adjustable, so as to produce flows of an entity from time to time commensurate with the different sensitivities of the two detectors (UV and MS) based on the molecule under study, i.e. requires hardware changes.

The article “Determination of C-7 isomer distribution in commercial feedstocks by GC-Matrix Isolation-FT-IR-MS” describes a solution in which a flame ionization detector (FID) is connected in parallel downstream of a gas chromatograph, an IR spectrophotometer, and a mass spectrometer. The compound is analyzed by MI IR, and is therefore mixed with argon, and deposited on a support maintained at a temperature of about 12 K. This solution, however, is not fully satisfactory as it requires adding argon to the flow entering the IR spectrometer, in addition to to the fact of maintaining the support at a temperature of 12 K, for which it is necessary to use liquid helium. Furthermore, the use of retention times as a parameter for the identification of a compound makes the method not very reproducible, since the retention times are notoriously unstable since they are subject to even considerable variations in relation to the type of stationary phase and to the method used for the separation (temperature conditions, flow).

WO 2019/161382 describes a method for the acquisition, processing and analysis of mass spectrometry data of pure compounds, also applicable to mixtures comprising several chemical compounds, which are preliminarily separated according to the different retention times in a chromatographic system. However, this solution is not fully satisfactory, since the use of these two information alone is not sufficient to guarantee detailed conclusions about the structure and therefore the identity of a specific molecule, in particular in the case of structural isomers and diastereomers.

### OBJECTIVES OF THE INVENTION

The object of the invention is to propose an apparatus for the chemical analysis of a sample which overcomes, at least in part, the drawbacks of known solutions.

Another object of the invention is to propose an apparatus which substantially simultaneously provides both information on the molecular weight of the compounds contained in the sample under examination, and information on the structure of said compounds.

Another purpose of the invention is to propose an apparatus which substantially provides, in a single analysis, both information on the retentive behavior of the compounds contained in the sample under examination, and information on the molecular weight of the compounds contained in the sample under examination, and information on the molecular structure of said compounds.

Another object of the invention is to propose an apparatus which allows to identify the chemical compound or compounds contained in the sample in an accurate and precise way.

Another object of the invention is to propose an apparatus with high specificity and sensitivity.

Another object of the invention is to propose an apparatus which allows a greater speed and completeness of analysis.

Another object of the invention is to propose an apparatus which can be obtained simply, quickly and with low operating costs.

Another object of the invention is to propose an apparatus which allows to recognize structural isomers and diastereoisomers.

Another object of the invention is to realize an apparatus which is highly integrated.
Another object of the invention is to propose an apparatus which is completely automated.
Another object of the invention is to propose an apparatus which allows to significantly reduce the analysis times.
Another purpose of the invention is to propose an apparatus which provides an analytical datum completely independent from the intervention and from the users skills.
Another object of the invention is to propose an apparatus which receives a sample to be analyzed at its input and at its output provides an indication of the compound or compounds contained in the sample with an accuracy level greater than 90%, preferably greater than 99%.

Another object of the invention is to provide an apparatus which is easy and quick to use, even by non-specialized users.

Another object of the invention is to realize an apparatus that can be used for forensic analysis.

Another object of the invention is to propose an apparatus which is alternative and/or improved with respect to traditional analytical solutions.

Another object of the invention is to propose an apparatus which has an alternative characterization, both in constructive and functional terms, with respect to traditional solutions.

### SUMMARY OF THE INVENTION

All these objects, considered both individually and in any combination thereof, and others which will result from the following description, are achieved, according to the invention, with an apparatus for analyzing a sample with the characteristics indicated in the claim 1.

### DESCRIPTION OF THE FIGURES

The present invention is further clarified hereinafter in some of its preferred embodiments reported for purely illustrative and non-limiting purposes with reference to the attached drawing tables, in which:

FIG. 1A shows a schematic view of a (first) embodiment of the apparatus according to the invention,

FIG. 1B schematically shows an embodiment of the apparatus according to the invention in which the chromatographic module is a gas chromatograph,

FIG. 1C shows a schematic view of a form embodiment of the apparatus according to the invention in which the chromatographic module is a liquid chromatograph,

FIG. 2 schematically shows the apparatus according to the invention in a different (second) embodiment,

FIG. 3 schematically shows in section a transfer line between the chromatographic module and the module for IR spectrophotometry,

FIG. 4 shows a schematic view of the apparatus according to the invention in a further and different (third) embodiment,

FIG. 5 shows a block diagram of the processing carried out by the software module of the processing unit,

FIG. 6 shows a block diagram of an alternative processing carried out by the software module of the processing unit,

FIG. 7 shows the chromatogram of a commercial perfume sample, in which an unknown compound is marked, subsequently identified as (E)-cyclohexadec-5-enone (CAS 35951-24-7), commonly known as trans-Toray musk,

FIGS. 8AC show the EI-MS spectra of the unknown compound (FIG. 8A) and of the cis- (FIG. 8B) and trans- (FIG. 8C) isomers of cyclohexadec-5-enone, respectively,

FIGS. 9AC show the FT-IR spectra of the unknown compound (FIG. 9A) and of the cis- (FIG. 9B) and trans- (FIG. 9C) isomers of cyclohexadec-5-enone, respectively,

FIG. 10 shows the chromatogram of an olive oil sample, in which three unknown compounds are marked, subsequently identified as “oleuropein aglycone”, with compound molecular formula C₂₅H₃₂O₁₃ and molecular weight 378),

FIG. 11 shows the ESI-MS spectra of the three compounds marked in FIG. 10,

FIG. 12 shows the solid phase FTIR spectra obtained for the three compounds marked in FIG. 10.

### DETAILED DESCRIPTION OF THE INVENTION AND OF SOME OF ITS PREFERRED FORMS OF CONSTRUCTION

### Apparatus

The analytical apparatus 1 according to the invention allows the chemical analysis of a sample S, in particular to identify the chemical compound or compounds contained in a mixture of a sample to be analyzed. Conveniently, the apparatus 1 can be used to recognize/identify the chemical compound or compounds present in a sample S injected into the apparatus itself, for example to reveal the presence of illicit compounds or of particular substances within a cosmetic or other type of mixture.

As is clear from the figures, the analytical apparatus 1 according to the invention comprises three modules:
a chromatographic module, in particular a chromatographic module 2,
a module for mass spectrometry (MS) 3,
a module for infrared (IR) spectroscopy 4.

In particular, the apparatus 1 comprises, in sequence, a chromatographic module 2 which, at the output, is connected—separately and in parallel with each other—both to the mass spectrometry module (MS) 3 and to the module for infrared (IR) spectroscopy 4. More in detail, the chromatographic module 2 is coupled in parallel to the module 3 for mass spectrometry and to the module 4 for IR spectroscopy.

Conveniently, in this way it is possible to use two analysis modules 3 and 4 which both perform destructive analyzes of the sample, ie in which the compound to be analyzed is no longer usable following the analysis itself. Furthermore, the use of a parallel arrangement of the modules (detectors) for mass spectrometry (MS) 3 and that for infrared spectroscopy (IR) 4 allows to separate (split) the flow leaving the separation column into two flows of different entity, in relation to the different sensitivity of the two detectors.

### Chromatographic Module 2

Conveniently, the chromatographic module 2 receives at its input the mixture of the sample S to be analyzed and, at its output, it is connected in parallel to the input of the mass spectrometry (MS) module 3 and to the input of the module for infrared (IR) spectroscopy 4. Conveniently, the output of the chromatography module 2 is fluidically connected, in particular by means of sealed connections, with the module 3 for mass spectrometry (MS) and with the module 4 for infrared spectroscopy (IR).

The chromatographic module 2 is configured to separate the compounds that make up the mixture of the sample S to be analyzed. Furthermore, the chromatographic module 2 can also be configured to detect the retention time and calculate the linear retention index (“Linear Retention Index” or “LRI”) of at least one compound of said sample S. Conveniently, the compounds separated from the chromatographic module 2 and outgoing from the latter are then sent in input to the mass spectrometry (MS) module 3 and to the infrared (IR) spectroscopy module 4.

In a preferred embodiment, the chromatographic module 2 comprises at least one chromatograph, preferably a gas chromatograph (GC) or a liquid chromatograph (LC) or a high performance liquid chromatograph (HPLC), and more preferably a gas chromatograph for analysis on capillary columns, which in particular is configured to separate the compounds contained in the sample S to be analyzed injected at the inlet of the apparatus 1. Conveniently, the separator device 2 can also comprise more than one of the aforementioned devices, which can o be positioned in parallel or, preferably, in series, in order to increase the resolving power of the apparatus.

Conveniently, in a possible embodiment, the chromatographic module 2 can comprise at least one of the following devices:
a gas chromatographic (GC) device, in particular in the case of volatile or gaseous molecules,
a liquid chromatography (LC) device and/or a high performance liquid chromatography (HPLC) device, in particular in the case of non-volatile and/or high molecular weight molecules,
a device for supercritical (SFC) or subcritical (sub-SFC) fluid chromatography with characteristics similar to GC and HPLC.

Conveniently, if said chromatographic module 2 comprises at least one device—in particular LC or HPLC—configured to separate substances in the liquid state and/or dissolved in a solvent, the apparatus can comprise an interface 12 for removing the solvent (mobile phase) leaving the LC or HPLC device. Preferably, the interface 12 is positioned externally with respect to the casing of the chromatographic module 2 and is positioned upstream with respect to the module 4 for infrared IR spectroscopy.

Advantageously, the separation column forming part of the chromatographic module 2 can be contained inside an environment heated to a high temperature or in any case at a controlled temperature, for example inside an oven.

Conveniently, as is known, the different compounds can have different retention times inside the chromatographic column according to the different structure and/or chemical composition. In particular, appropriately, the linear retention indices (LRI) are calculated starting from the linear retention times detected. More in detail, “LRI” means a parameter described by the following equation:

$$L R {I}^{T} = 100 + [ z + \frac{( {t}_{{R}_{i}}^{T} - {t}_{{R}_{z}}^{T} )}{( {t}_{{R}_{\{ z + 1 \}}}^{T} - {t}_{{R}_{z}}^{T} )} ] \qquad Eq . 1$$

where:
T is the temperature,
LRI^{T} is the Linear retention index at temperature T,
z is the number of carbon atoms of a reference alkane,
t_{R} is the retention time (given by the equation t_{R}=t_{M}+t′_{R} where t_{M} is the time elapsed by a molecule in the mobile phase, and t′_{R} corresponds to the time elapsed by the molecule in the stationary phase),
t_{Ri} is the retention time of the analyzed compound.

The retention time is influenced by the adsorption/desorption processes of the molecules that make up the mixture to be analyzed in the stationary phase, as well as by the geometry of the chromatographic column. In particular, therefore, the LRI can be considered as specific to the compound analyzed and to the system in which it is analyzed. Preferably, the alkanes used as standard for the calculation of the LRI can be n-alkanes with a linear chain with a number of carbon atoms between 7 and 30 (n-paraffins).

Conveniently, at least one chromatograph of the chromatographic module 2 can be of a substantially traditional type and, in particular, it comprises at least one chromatographic column, inside which there is a suitable matrix or “stationary phase”, configured to move the mixture made up from the sample S to be analyzed and from the mobile phase—preferably in the vapor or liquid phase.

Conveniently, the chromatographic module 2 can also comprise, in particular at the outlet of the chromatographic column, also a dedicated detector—for example a flame ionization detector (FID) or other known detectors suitable for the purpose—to detect the retention time of the compounds and thus being able to calculate the LRI values of the compounds present in the sample S.

Advantageously, in the chromatographic module 2, the output of the chromatographic column can be connected to a suitable detector configured to detect the passage of gaseous mixtures.

Advantageously, in the chromatographic module 2, the output of the chromatographic column can be connected to a suitable detector configured to detect the passage of mixtures in the liquid state.

Advantageously, in a possible embodiment of the apparatus 1, the injection of the sample S to be analyzed in the chromatographic module 2 can be carried out in split-mode, with a ratio of 1:10. Advantageously, the temperature at the inlet of the chromatographic module 2 can be higher than about 200° C., and preferably about 280° C.

### Module 3 for Mass Spectrometry

Conveniently, module 3 for mass spectrometry is configured to detect and/or calculate the mass spectra of at least one compound (contained in the sample S to be analyzed) that comes out—separately from any other compounds contained in the sample—from said chromatographic module 2.

Conveniently, module 3 for mass spectrometry comprises a mass spectrometer to measure the mass of the compounds present within the sample S to be analyzed, in particular after said compounds have come out, separately between them, from the chromatographic module 2.

Preferably, the mass spectrometer of the module 3 is substantially conventional. Conveniently, module 3 comprises a mass spectrometer which can be of the quadrupole or time-of-flight type. Advantageously, in a possible embodiment of the invention, the mass spectrometer of the module 3 can be configured to analyze ratios m/z ranging from 40 to 500 μm. Conveniently, module 3 comprises an electron impact source (EI-MS) or electrospray (ESI-MS) or other type of source.

### Module 4 for Infrared Spectroscopy

Module 4 for infrared (IR) spectroscopy is configured to detect and/or calculate the infrared (IR) spectra of at least one compound (contained in the sample S to be analyzed), which comes out—separately from any others compounds contained in sample S—by said chromatographic module 2.

Conveniently, module 4 for IR spectroscopy comprises an IR spectrophotometer, configured to perform spectrophotometric measurements on the compounds present within the sample S to be analyzed, in particular after they are separately released from the chromatographic module 2.

Conveniently, the IR spectrophotometer is substantially traditional. Preferably, the IR spectrophotometer is a Fourier transform (FT-IR or FTIR). Preferably, the IR spectrophotometer is configured to perform photo-absorption measurements in the infrared (in particular in the mid-infrared, for example at wavelengths between 4000 and 700 cm⁻¹) on the chemical compounds that make up the mixture of the sample S to analyze.

Advantageously, the use of IR spectroscopy allows to obtain information on the structure of the analyzed compound and, in particular, on the geometry of the chemical bonds of the compound.

Advantageously, in a possible embodiment of the invention, the module 4 for IR spectroscopy can comprise a plate cooled to about −50° C. on which the compound to be analyzed is condensed. Advantageously, said plate can be rotated, for example at 3 mm/min, during the analysis, in order to optimize the quality of the spectrum obtained.

Conveniently, module 4 for IR spectroscopy is direct deposition (DD), in particular it provides for the solid deposition of the analyte on a support in material transparent to IR radiations, for example it can be made of ZnSe, or silica, or quartz melted. Preferably, said deposition support is disk-shaped. Conveniently, said deposition support is cooled, preferably to a temperature higher than −100° C. Advantageously, the compound to be identified can be deposited on the support by means of a capillary tube or duct positioned in close proximity to the support itself, so as to allow analysis immediately after deposition. Conveniently, the support can be rotated.

Conveniently, in this way it is possible to obtain a sensitivity at least two orders of magnitude higher than that typical of light pipes, and also a greater effective spectral resolution (4 cm⁻¹). As a result of the narrow absorption bands compared to those obtained by molecules free to rotate in the gas phase (with consequent centrifugal distortion), the resolution of the technique is also increased, and the consequent ability to differentiate structurally highly correlated molecules. Furthermore, the analytes remain deposited until the window, or disk, of ZnSe is allowed to return to room temperature, so it is possible to do a “post-run” average of the signal to increase the signal-to-noise ratio (S/N). and, consequently, sensitivity. Furthermore, the upper limit of the temperature program used for GC separation will be dictated exclusively by the chromatographic system and not by the IR detector, as is the case with the light pipe interface.

### Splitting Device 10

Conveniently, module 3 for mass spectrometry and module 4 for IR spectroscopy are connected, in parallel with each other, with the output of separation module 2 so that the flow of compounds that exit separately from said separation module 2 is subdivided/split between module 3 for mass spectrometry and module 4 for IR spectroscopy.

Conveniently, the apparatus 1 comprises a splitting device 10 which is fluidically connected at the input with the output of the separation module 2 and at the output is connected in parallel with the module 3 for mass spectrometry and the module 4 for spectroscopy. IR.

Conveniently, the splitting device 10 is configured for:
send in parallel, and in a controlled and reproducible manner, the outgoing flow from the separation module 2 to the two modules for mass analysis 3 and for IR spectroscopy 4 in parallel,
allow the subdivision of the outgoing flow from the separation module 2 into two flows of an entity commensurate with the different sensitivity and acquisition speed of the detectors of the two modules 3 and 4,
do not alter the chemical nature of the compounds leaving the separation module 2,
do not interfere with the separation of compounds obtained by means of the separation module 2,
minimize the introduction of dead volumes.

Conveniently, the splitting device 10 is defined by a 3-way fitting—for example a “T”
with an inlet and two outlet ways, in which in particular the inlet is fluidically connected to the output of the module separation 2 while the two outlet ways are fluidically connected in parallel respectively with the inlet of module 4 for IR spectroscopy and with module 3 for mass spectrometry.

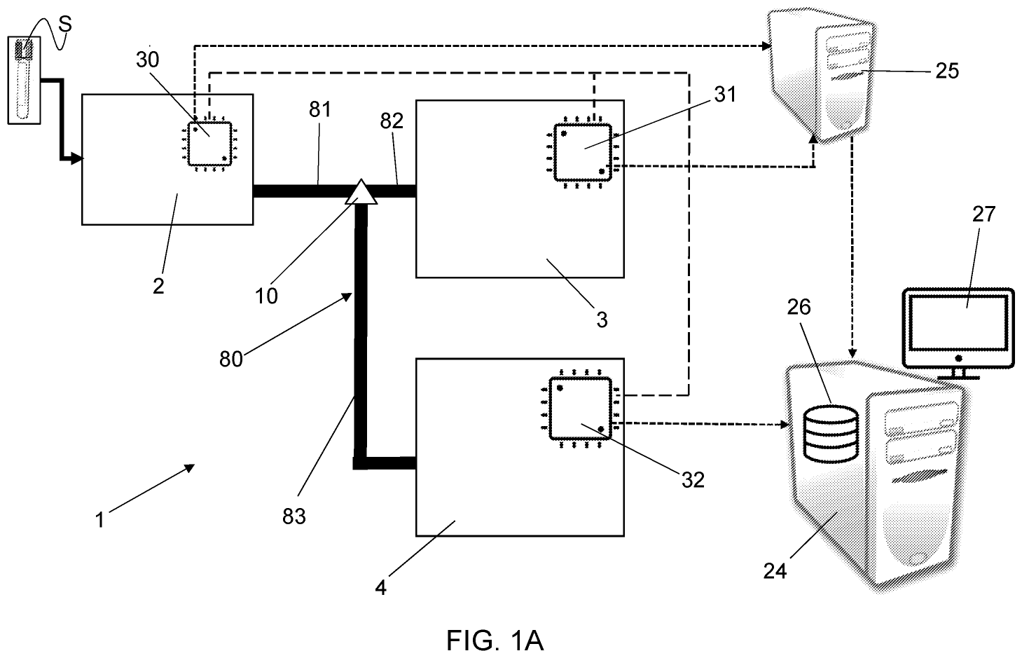

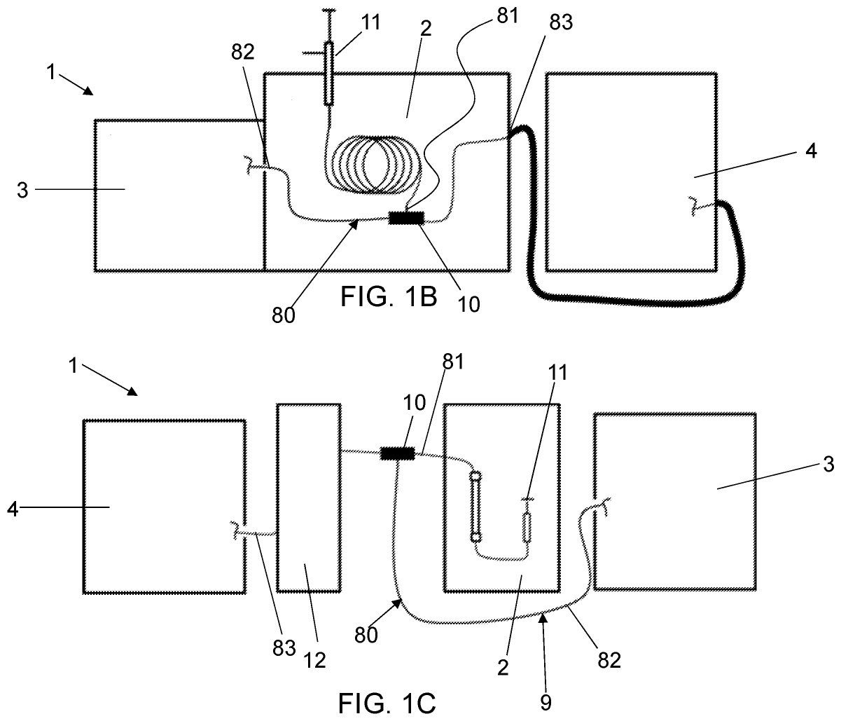

Conveniently, the splitting device 10 can be housed inside the casing of the separation module 2 (see FIG. 1B) and/or can be housed outside the latter (see FIG. 1C) and also inside of the other modules 3 and 4. Preferably, the splitting device 10 can be mounted in the transfer interface 80 at the point of said line where the two branches branch off respectively towards module 3 and towards module 4.

Conveniently, in a possible embodiment, the fluidic connection between the separation module 2 and the module 4 for IR spectroscopy and/or the module 3 for mass spectrometry comprises a splitting device 10 which, preferably, is defined by a valve, and more preferably it can be for example a solenoid valve. Preferably, said valve is three-way, with one inlet and two outlet ways, in which in particular the inlet way is fluidically connected to the outlet of the separation module 2 while the two outlet ways are fluidically connected in parallel with the input of module 4 for IR spectroscopy and with module 3 for mass spectrometry respectively.

### Control and Processing Unit of the Modules

Advantageously, in a possible embodiment (see FIG. 1) the chromatographic module 2 can comprise a dedicated control and processing unit, hereinafter also defined as “first control unit” 30 which is configured to command, coordinate and manage the operation of the chromatographic module 2. Preferably, said first control and processing unit 30 comprises a processor or a controller. Preferably, said first control and processing unit 30 is also configured for the acquisition of the corresponding data detected by the chromatographic module 2. Advantageously, said first control and processing unit 30 is connected to the detector of the chromatographic module 2, in order to control its operation and acquire the data, in order to calculate the LRIs.

Conveniently said first control unit 30 can be configured to calculate the LRI values of the compounds analyzed.

In particular, the chromatographic module 2, in addition to solving a mixture of compounds in the sample S in fractions of lesser complexity or in the single pure components, can also be configured to provide complementary information, i.e. retention data (times), which are useful for the identification of the components separated from the module itself. Since the retention times are subject to even considerable variations in relation to the type of stationary phase and to the method used for separation (temperature conditions, flow), the apparatus 1 according to the invention is configured to calculate starting from the time data of retention the Linear Retention Indices (LRI) and this in order to standardize/stabilize the retention data in a standardized system. In particular, the LRI values define the retention behavior of the compounds of interest according to a uniform scale defined by a series of strictly correlated standard compounds, and are calculated by applying appropriate equations, developed for isothermal GC analyzes and for GC analyzes at programmed temperature. Both methods measure relative retention time using a homologous series of reference solutes.

In particular, the retention index (LRI) system uses a homologous series of straight-chain hydrocarbons (normal (n−) paraffins) as reference solutes. In particular, in isothermal GC conditions, the retention times of the components of this homologous series increase exponentially, based on a semi-logarithmic relationship between the correct retention times of the hydrocarbons (log(t′_{Ri})) and their number of carbon atom (cₙ), where a and b are constants:

log(t′_{Ri})=αcₙ+b Eq. 2

The indices of which can be composed comprised between two hydrocarbon peaks, named and n+1, be calculated with the following:

$$L R I = 10 \; 0 [ n + \frac{log {t}_{R ( i )}^{′} - log {t}_{R ( n )}^{′}}{log {t}_{R ( n + 1 )}^{′} - log {t}_{{R}_{( n )}}^{′}} ] \qquad Eq . 3$$

Where “n” indicates the length of the hydrocarbon carbon chain and “i” indicates the analyte. In the system based on the retention indices, each analyte is indicated on the basis of the position between two n-hydrocarbons which elute immediately before and after the compound; the calculation is based on a linear interpolation of the number of carbon atoms of the two hydrocarbons (the latter can be multiplied by 100, in order to avoid the use of decimal fractions). The retention time of a solute is therefore equal to the number of carbons (×100) of a hypothetical n-paraffin which should have the same corrected retention time of the specific solute.

On the other hand, in a programmed temperature analysis, the series of n-paraffins elutes in a linear way, in the sense that for each peak a constant increase in the retention time is observed, compared to that of its predecessor. The relationship between the retention times and the number of carbon atoms will be:

t_{R}^{T}=α′·cₙ+b′ Eq. 4
where a′ and b′ are two constants of proportionality.

In the case of scheduled temperature analysis, the retention index is expressed as follows:

$$L R I = 100 n + 100 \frac{{t}_{Ri} - {t}_{Rn}}{{t}_{R ( n + 1 )} - {t}_{Rn}} \qquad Eq . 5$$

Advantageously, in addition to the n-paraffins, other homologous series can be used as reference standards for the calculation of the LRI, such as the methyl esters of fatty acids, ethyl esters of fatty acids, triacylglycerols, alkyl-aryl-ketones, etc.

The use of retention indices represents a robust method for qualitative analysis; in order to standardize these reference values as much as possible, it is essential to ensure not only the repeatability, but also the reproducibility of the method, through the use of replicates both in the preparation of the sample and in the analyzes, and an adequate statistical treatment of the data. The identification of a compound can also be supported by the calculated (LRIₜₕₑₒᵣ) and experimental (LRIₑₓₚ) retention indices. It should also be borne in mind that GC separations employ stationary phases of very different polarity, operated in a wide range of temperatures, therefore no substance can meet the requirements of a universal standard. Marked differences in the retention of sample and standard components will cause damage to accuracy. Conveniently, the reliability of the identification will ultimately depend on the reproducibility of the indexes, which in turn determines the size of the tolerance “window” to be used as a criterion for the library search. The smaller the latter, the greater the probability that two peaks corresponding to two consecutively eluted compounds will be discriminated by the LRI filter. However, very similar compounds will have very close retention indices, in which case the use of selective spectroscopic detectors will be essential to provide complementary information that allows unambiguous and accurate identification.

Advantageously, in the case where the chromatographic module 2 includes an HPLC, where the standardization of the experimental conditions is more complex than the GC counterpart, given the much higher number of possible stationary phase/mobile phase combinations and the active role that the latter plays In the chromatographic separation process, LRIs can be used due to the high lot-to-lot reproducibility of modern HPLC columns and recent advances in instrumentation. These factors make the LRI system in liquid chromatography particularly reliable in terms of reproducibility. Conveniently, if the chromatographic module 2 includes a device for HPLC, n can indicate the length of the carbon chain of a compound belonging to a reference homologous series consisting of triacylglycerols with fatty acids having an odd number of carbon atoms, used for the calculation of LRI.

Advantageously, in a possible embodiment (see FIG. 1) the module 3 for mass spectrometry can comprise a dedicated control and processing unit, hereinafter also defined as “second control unit” 31 which is configured to control, coordinate and manage the operation of module 3 for mass spectrometry. Preferably, said second control and processing unit 31 comprises a processor or a controller. Preferably, said second control and processing unit 31 is also configured for the acquisition of the corresponding data detected by the module 3 for mass spectrometry, in particular for acquiring/calculating the mass spectra of the compounds.

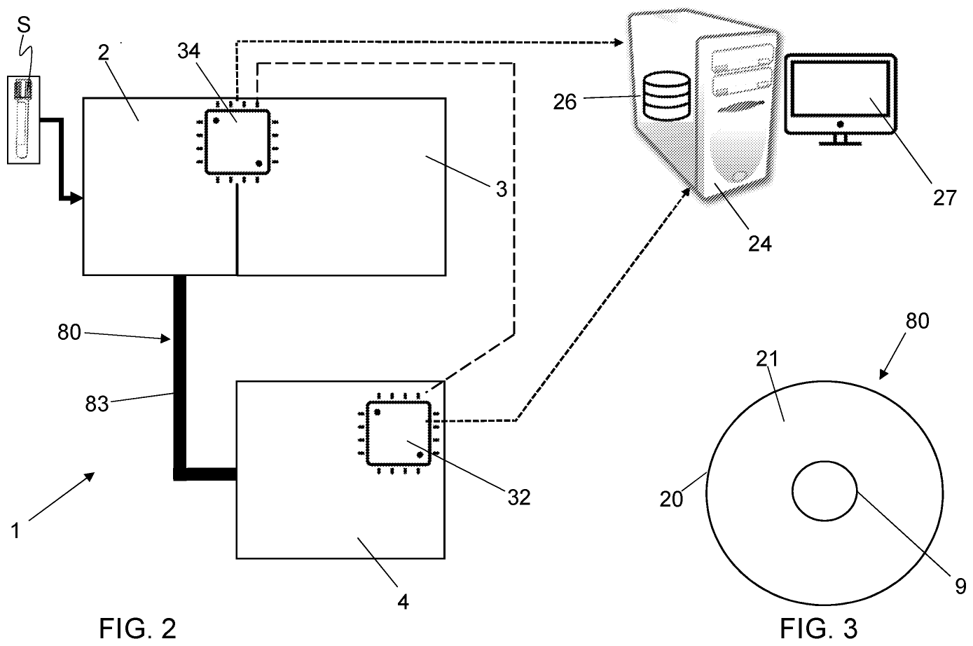

Advantageously, in a possible embodiment (see FIGS. 1 and 2) the module 4 for IR spectroscopy can comprise a dedicated control and processing unit, hereinafter also defined as “third control unit” 32 which is configured for command, coordinate and manage the operation of module 4 for IR spectroscopy. Preferably, said third control and processing unit 32 comprises a processor or a controller. Preferably, said third control and processing unit 32 is also configured for the acquisition of the corresponding data detected by the module 4 for the IR spectroscopy, in particular to acquire/calculate the IR spectra of the compounds.

Advantageously, in a possible embodiment (see FIG. 2), the chromatographic module 2 and the module 3 for mass spectrometry define a single integrated block, to which the module 4 for IR spectroscopy is associated so that it is fluidically connected to an output of the chromatographic module 2. Preferably, in this case, in addition to the control and processing unit 32 of the module 4 for IR spectroscopy, a shared control and processing unit 34 is provided which controls, coordinates and manages the operation of both the chromatographic module 2 and the module 3 for mass spectrometry. Preferably, said shared control and processing unit 34 can also be configured to acquire the corresponding data detected by the chromatographic module 2 and by the mass spectrometry module 3.

Conveniently, in a possible embodiment not shown, the chromatographic module 2 and the module 4 for IR spectroscopy define a single integrated block, to which the module 3 for mass spectrometry is associated so that it is fluidically connected with a output of the chromatographic module 2. Preferably, in this case, in addition to the control and processing unit 31 of the mass spectrometry module 3, a shared control and processing unit 34 is provided which controls, coordinates and manages the operation both of the chromatographic module 2 and of the module 4 for IR spectroscopy. Preferably, said shared control and processing unit 34 can also be configured to acquire the corresponding data detected by the chromatographic module 2 and by the module 4 for IR spectroscopy.

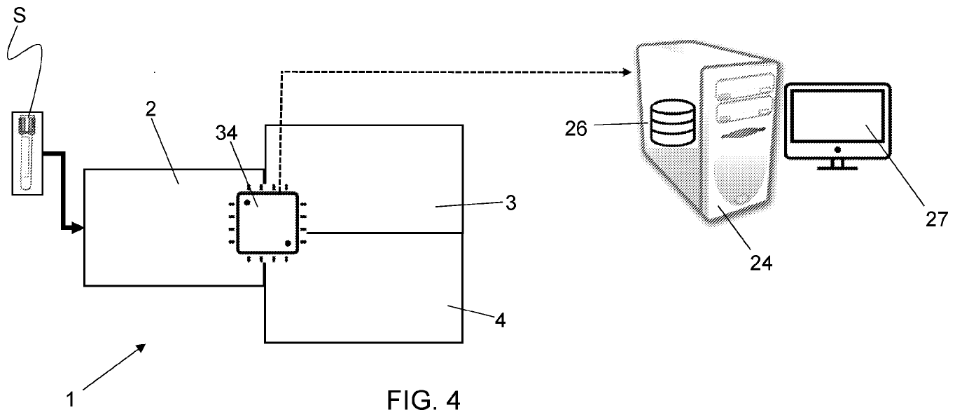

Advantageously, in a different and further embodiment (see FIG. 4), the chromatographic module 2, the module 3 for mass spectrometry and the module 4 for IR spectroscopy define a single integrated block, in which a a single shared control and processing unit 34 which controls, coordinates and manages the operation of both the chromatographic module 2 and the module 3 for mass spectrometry and the module 4 for IR spectroscopy. Conveniently, in this case, said shared control and processing unit 34 can also be configured to acquire the corresponding data detected by the chromatographic module 2, by the module 3 for mass spectrometry and by the module 4 for IR spectroscopy, to send them to a processing unit 24 (as will be better specified below).

Advantageously, the control and processing units 30, 31 and 32 of the three modules (respectively 2, 3 and 4), or the shared electronic unit 34 and the third control and processing unit 32, or the shared electronic unit 34 and the second control and processing unit 31 are electronically connected to each other to thus allow the exchange of command, status and/or synchronization signals (of the “ready/not ready” type).

Advantageously, the control and processing units 30, 31 and 32 of the three modules (respectively 2, 3 and 4), or the shared electronic unit 34 and the third control and processing unit 32, or the shared electronic unit 34 and the second control and processing unit 31 are configured to implement a “master/slave” type architecture where, for example, the control and processing unit 32 of the module 4 for IR spectroscopy operates as a master, while the other (34) or the other (30 and 31) control and processing units of the other modules operate/operate as slaves, or vice versa.

### Transfer Interface 80

Conveniently, the apparatus 1 can comprise at least one transfer interface 80, which preferably comprises at least a first transfer line 81 for the fluidic connection of the chromatographic module 2 with the splitting device 10, a second transfer line 82 for the fluidic connection of the chromatographic module 2 and/or of the splitting device 10 with the module 3 for mass spectrometry, a third transfer line 83 for the fluidic connection of the chromatographic module 2 and/or of the splitting 10 with module 4 for IR spectroscopy. Preferably, the transfer interface 80 is configured to transport the compounds, contained in the mixture of the sample S to be analyzed, separated from the chromatographic module 2 to the module 4 for IR spectroscopy and/or to the module 3 for mass spectrometry.

Conveniently, in a possible embodiment in which the chromatographic module 2 comprises at least one GC device, the transfer interface 80 comprises a first transfer line, for the fluidic connection of the chromatographic module 2 with the splitting device 10, which is defined by the terminal end of the column located inside the same module 2.

Conveniently, the transfer interface 80 comprises said splitting device 10 which is fluidically connected in input with the output of the chromatographic module 2, and in in particular by means of the first transfer line 81 or by means of the terminal end of the column placed inside the same module 2, and at the output it is connected in parallel with the module 3 for mass spectrometry by means of the second transfer line 82 and with the module 4 for the IR spectroscopy by means of the third transfer line 83. Advantageously, said first 1 transfer line 81, or said terminal end of the column, fluidically connect the outlet of the chromatographic module 2 with the inlet of the splitting device 10, the second transfer line 82 connects a first outlet of the splitting device 10 with the inlet of module 3 for mass spectrometry and the third transfer line 83 connects the second output of splitting device 10 with the input of module 4 for IR spectroscopy.

Conveniently, at least one transfer line 81 (or the terminal end of the column of the chromatographic module 2), 82 and 83 of the transfer interface 80 can be at least partially, and preferably entirely, housed inside the respective casings of the separation modules. 2 and modules 3 and/or 4. Conveniently, at least one transfer line 81 (or the terminal end of the column of the chromatographic module 2), 82 and 83 of the transfer interface 80 can run—at least in part—externally with respect to to the carters of the separation modules 2 and of the modules 3 and/or 4.

Conveniently, at least one transfer line 81, 82 and 83 of the transfer interface 80 can have a length of at least 20 cm.

Advantageously, the transfer interface 80 can be configured for:
allow the flow through the transfer lines 82 and 83 to fully reach module 3 for mass spectrometry and/or module 4 for IR spectroscopy, in a controlled and reproducible manner,
keep all compounds separated in the vapor phase, including by heating to a suitable temperature,
ensure the maintenance of a homogeneous temperature profile without fluctuations along its entire length, to avoid the formation of sub-heated areas (cold spots) where the analytes can condense and hot spots where the analytes can decompose,
ensure adequate thermal insulation, to avoid heat conduction to the outermost layers.

Conveniently, the control and reproducibility of the flows are ensured by the geometry of the splitting device 10 and by the dimensions in terms of length and/or internal diameter of the transfer lines 82 and 83 leaving said device. In particular, advantageously, in order to reduce the flow (and therefore the quantity of analyte/s) to be sent to module 3 for mass spectrometry which, being more sensitive, is destined to receive a smaller quantity of eluate from the separation column, for the second transfer line 82 it is possible to use a tube of greater length and/or of smaller internal diameter than the tube used for the third transfer line 83 directed to the module 4 for IR spectroscopy. Conveniently, the dimensions (in terms of length and internal diameter) of the pipes of the transfer lines 82 and 83 and the pressures at the head of the same pipes determine the speed of the flow inside the transfer lines.

The splitting device 10 and the transfer interface 80 allow considerable flexibility and, in particular, the flows directed to the two modules 3 and 4 can be easily adjusted, by replacing the tubes of the transfer lines 82 and 83 with other tubes of different dimensions, without the need to make hardware changes to the apparatus 1, and this according to the needs of the specific analysis, also in relation to the type of molecule (analyte).

Conveniently, the transfer lines 81 (or the terminal end of the column of the chromatographic module 2), 82 and 83 of the transfer interface 80 are configured, at their respective ends, so as to allow mechanical and fluidic connection with the chromatographic module 2 on one side and with module 3 for mass spectrometry and/or with module 4 for IR spectroscopy on the other side. Preferably, for this purpose, the transfer lines 81 (or the terminal end of the column of the chromatographic module 2), 82 and 83 of the transfer interface 80 can have suitable connectors at their respective ends.

Advantageously, the transfer line 81, 82 and/or 83 of the transfer interface 80 can comprise a tube or a capillary duct 9 inside which the compounds pass/flow.

Conveniently, the transfer interface 80 can comprise:
a first end which is fluidically connected to the outlet of at least one chromatographic column of the separation module 2, so as to allow the compounds leaking out and separated from the separation module 2 to be inserted into the tube or capillary itself,
another (second) end which is fluidically connected to the inlet of the mass spectrometry module 3 for the inlet of the compounds to be analyzed in said module,
another (third) end which is fluidically connected with the inlet of the module for IR spectroscopy for the inlet of the compounds to be analyzed in said module and/or is fluidically connected with an interface 12 for the removal of the solvent (mobile phase) output from the LC or HPLC device.

Preferably, the transfer line 81, 82 and/or 83 of the transfer interface 80 can comprise a capillary tube or duct 9 made of a material resistant to high temperatures. Preferably, said tube or capillary duct 9 can be made of inert material from a chemical point of view, even with respect to the compounds leaving the column of the separation module 2, and for example it can be made, at least partially, of quartz or fused silica or in polymeric material or steel, preferably subjected to a surface treatment, called “deactivation” in order to minimize its reactivity.

Conveniently, the capillary tubes or ducts 9 of the transfer interface 80 comprise capillaries of deactivated fused silica and are characterized by the absence of stationary phase (present in the separation column) and therefore not able to interfere with the chromatographic separation carried out in the module. 2.

Conveniently, the capillary tubes or ducts 9 of the transfer interface 80 comprise tubes of polymeric material or steel and are characterized by the absence of stationary phase (present in the separation column) and therefore not capable of interfering with the separation chromatographic performed in module 2.

Conveniently, the transfer line 81, 82 and/or 83 of the transfer interface 80 may comprise comprises tube or capillary conduit 9 having a diameter of about ¼ of an inch. Conveniently, the dimensions and geometry of the splitting device 10 are such as to ensure the extremely rapid transfer (e.g. extremely high local linear speed) of the compounds leaving module 2 towards the two modules 3 and 4, in order to maintain the separation space-time.

Advantageously, the transfer interface 80 can substantially have a “Υ” (ipsilon) configuration with two or three capillary tubes or ducts 9, in which in order to minimize the generation of dead volumes, the column and the tubes or capillaries can be installed by inserting them so as to occupy the entire length of the channels, using a conical ferrule type of the appropriate size and material in order to create perfectly sealed connections.

Conveniently, in a possible embodiment, the transfer interface 80 can comprise two branches and, in particular, a branch 83 connected to the input of the compounds to be analyzed in said module 4 for IR spectroscopy, while the other branch 82 is connected to the input of the compounds to be analyzed in said module for mass spectrometry 3.

Conveniently, in a possible embodiment the transfer interface 80 can be configured to select whether to send the compound leaking from the chromatographic module 2 to the module 4 for IR spectroscopy and/or module 3 for mass spectrometry by means of an appropriate valve. Preferably, said valve can be motorized and remotely controlled.

Advantageously, the connections of the transfer interface 80, and preferably of the capillary tubes or ducts 9, to the module 4 for IR spectroscopy and/or to the module 3 for mass spectrometry are sealed, so as to avoid contamination of the sample S to be analyzed and/or leakage of the sample itself from the transfer line.

Advantageously, said transfer interface 80 can be configured to distribute to the module 3 for mass spectrometry and to the module 4 for infrared spectroscopy the compounds to be analyzed that leave said chromatographic module 2, in proportions suitable for the different sensitivities of the instruments. In particular, therefore, the transfer interface can be configured to send a larger portion of compounds to be analyzed to module 4 for IR spectroscopy than that which is sent to module 3 for mass spectrometry. For example, it can be configured to send about 10% of the compound or compounds to be identified to module 3 for mass spectrometry and the remaining 90% of the compound or compounds to be identified to module 4 for infrared spectroscopy.

Conveniently in particular, for this purpose, the capillary tube or duct 9 of the second transfer line 82 and that of the third transfer line 83 can have different internal diameters and/or lengths. In particular, the tube or capillary duct of the second transfer line 82 can have a greater length and/or a smaller internal diameter than that of the third transfer line 83. In particular, in this way it is possible to modify the flow that is sent to each of the two modules without intervening on the two modules themselves, in particular without making hardware changes (skimmers, pumps), but simply by acting on the transfer interface 80.

Conveniently, in a possible embodiment, the transfer lines 81, 82 and/or 83 of the transfer interface 80 may comprise temperature control means (not shown) configured to maintain the corresponding transfer line, and in particular the corresponding tube or capillary 9, at a constant temperature, which is preferably predefined and/or preselected. Preferably, said temperature control means can be configured to maintain the capillary tube or duct 9 at a temperature above 300° C., and more preferably around about 350° C.

Advantageously, in a possible embodiment (see FIG. 3), the transfer lines 81, 82 and/or 83 of the transfer interface 80 comprise an outer casing 20 for containing the tube or capillary duct 9. Conveniently, the casing 20, for example made of steel, is configured to isolate the walls of the capillary duct 9 from the external environment. Conveniently, within the transfer lines 81, 82 and/or 83 of the transfer interface 80, the internal walls of the casing can be spaced from the external walls of the tube or capillary duct of the transfer interface 80, to define thus an interspace 21 to thus improve the thermal insulation of the tube or capillary duct 9 intended to be crossed by the compounds to be analyzed.

Advantageously, in the interspace 21 between said casing 20 and the tube or capillary duct 9, it can be carried under vacuum. In particular, the vacuum in the interspace 21 can be obtained by means of a pump provided in said module 3 for mass spectrometry and/or in said module 4 for IR spectroscopy.

Conveniently, in a possible embodiment, the casing 20 for containing the tube or capillary duct 9 can be supported by suitable support elements (not shown). Advantageously, said support elements can be made of any polymeric material since the external surface of the casing 20 is not at a high temperature; in particular, for example, the support elements can be made of acrylonitrile-butadiene-styrene (ABS), polylactic acid (PLA), polyvinyl alcohol (PVA), nylon, high-density (HDPE) or low-density polyethylene (PE) (LDPE), polyethylene terephthalate (PET), blend of polyethylene terephthalate and polyethylene glycol (PETG). Advantageously, said support elements can be made to measure, for example they can be made by means of suitable additive manufacturing procedures, and in particular they can be made by 3D printing.

### Injection Device

Conveniently, a sampler device 11, preferably of the traditional type, can be provided at the input of the chromatographic module 2, which is configured for the automatic injection of the sample S to be analyzed into at least one chromatograph of said module 2. Conveniently, in a possible embodiment, the injection of the sample S into the chromatographic module 2 can be carried out manually by means of suitable syringes or probes. Preferably, one end of the column (placed inside the oven or other heated environment) of the chromatograph is in connection—or is intended to be put in fluidic connection—with the device for automatic or manual injection of the sample S all inside the column itself.

### Processing Unit

The apparatus 1 may further comprise at least a processing unit 24 (for example a PC or processor) which is configured to receive the data of the retention times and/or of the retention indices (LRI) acquired/calculated from said chromatographic module 2, the data of the mass spectra acquired by said module 3 for mass spectrometry and the data of the IR spectra acquired by said module 4 for IR spectroscopy.

Conveniently, the processing unit 24 is connected—directly or through a further processing unit 25—with the chromatographic module 2, with the module 3 for mass spectrometry and with the module 4 for IR spectroscopy.

Conveniently, in a possible embodiment (see FIG. 1), the apparatus 1 comprises:
a processing unit 24 which is connected to the module 4 for IR spectroscopy and, in particular, is connected to the third control and processing unit 32 of said module 4,
a further processing unit 25 which is connected to the chromatographic module 2 and to the module 3 for mass spectrometry, and in particular is connected to the first 30 and second 31 control and processing units (of modules 2 and 3 respectively), or it is connected to the shared control and processing unit 34 of said modules 2 and 3.

In particular, said further processing unit 25 receives the data acquired by the chromatographic module 2 and by the mass spectrometry module 3, to determine so are the linear retention indices (LRIs) and mass spectra. Conveniently, the processing unit 24 receives the data acquired by the module 4 for IR spectroscopy, to thus calculate the data of the IR spectra and, furthermore, receives from said further processing unit 25 the data (calculated by said further unit) relating to linear retention indices (LRI) and mass spectra.

Conveniently, in a further (second) possible embodiment (see FIG. 2), a single processing unit 24 can be provided which is electronically connected to the shared control and processing unit 34 of the chromatographic module 2 and of the module 3 for mass spectrometry, and with the dedicated control and processing unit 32 (the third control unit) of module 4 for IR spectroscopy.

Conveniently, in a further (third) possible embodiment (see FIG. 4), a single processing unit 24 can be provided which is electronically connected to the shared control and processing unit 34 of the chromatographic module 2, of the module 3 for mass spectrometry and module 4 for IR spectroscopy.

Conveniently, in a further (fourth) possible embodiment not shown, a single processing unit 24 can be provided which is electronically connected to the shared control and processing unit 34 of the chromatographic module 2 and of the module 4 for IR spectroscopy, and with the dedicated control and processing unit 31 (the second control unit) of module 3 for mass spectrometry.

Conveniently, in a further (fifth) possible embodiment not shown, a single processing unit 24 can be provided which is electronically connected with the first (dedicated) control and processing unit 30 of the chromatographic module 2, with the second (dedicated) 31 control and processing unit of module 3 for mass spectrometry and with the third (dedicated) control and processing unit 32 of module 4 for IR spectroscopy.

Conveniently, as mentioned, said at least processing unit 24 receives (directly or through a further processing unit 25) the data acquired by each of the three modules, and in particular receives the data acquired by the chromatographic module 2, data acquired by module 3 for mass spectrometry and data acquired by module 4 for IR spectroscopy. More in detail, said at least one processing unit 24 receives:
the linear retention indices (LRI) data acquired from the chromatographic module 2,
mass spectra data acquired by module 3 for mass spectrometry,
the data of the IR spectra acquired by module 4 for IR spectroscopy.

Advantageously, said at least one processing unit 24 can have at least one computer with a suitable/traditional user interface 27 (for example a monitor with a keyboard or a touch-screen display), to allow the user to set/program the operation of the various modules and/or send commands for data processing, as well as to view the results of the processing performed.

Conveniently, said at least one processing unit 24 can be provided and/or connected to at least one memory 26. Advantageously, at least one organized archive (database or library) can be loaded into said memory 26 containing the data of the linear retention indexes (LRI), IR spectra and mass spectra of a plurality of known and predefined compounds.

Advantageously, in said at least one memory 26 are preloaded and stored in an organized manner—preferably in the form of at least one database—three libraries, of which:
a first library 40 containing the data of known and predefined compounds to be compared with the data acquired by means of the chromatographic module 2; in particular, the first library 40 contains a list of known chemical compounds, associated with the respective LRI data, preferably calculated under the conditions foreseen for their acquisition and on the chromatographic module used for their acquisition; preferably, the data of the first library 40 are obtained by previously acquiring, by means of a chromatographic module, the corresponding LRIs of a plurality of known compounds,
a second library 41 containing the data of known and predefined compounds to be compared with the data acquired by means of the module 3 for mass spectrometry; in particular, the second library 41 contains a list of known chemical compounds, with associated respective mass spectra and/or a series of quantities describing such mass spectra, such as for example the m/z values of the respective peaks and the relative intensity, and/or the values m/z of any fragments and the relative intensity; preferably, the data of the second library 41 are obtained by previously acquiring, by means of a mass spectrometry module, the mass spectra of a plurality of known compounds,
a third library 42 containing the data of known and predefined compounds to be compared with the data acquired by means of the module 4 for IR spectroscopy; in particular, the third library 42 contains a list of known chemical compounds, associated with the respective IR spectra and/or a series of quantities that describe these IR spectra, such as for example the wavelength and/or amplitude at the base and/or at half height and/or the intensity of at least some of the absorption peaks of the IR spectrum, and preferably of all the main absorption peaks present in the regions where the IR spectrometer is configured to perform the measurements; preferably, the data of the third library are obtained by previously acquiring, by means of an IR spectroscopy module, the IR spectra of a plurality of known compounds.

In essence, the three libraries 40, 41 and 42, which contain the data of the LRIs, mass spectra and IR spectra of known chemical compounds, thus define three corresponding comparison libraries, to be used precisely for comparison with the corresponding data relating to the compounds contained in the sample S to be analyzed and acquired respectively by the chromatographic module 2, by the module 3 for mass spectrometry and by the module 4 for the IR spectroscopy, to thus identify—on the basis of said comparison—the compounds contained in the sample S analyzed.

Conveniently, therefore, in the memory 26 the data of the LRI, of the IR spectra and of the mass spectra of a plurality of known compounds which act as reference standards are stored.

Advantageously, the compounds present in the first library 40, in the second library 41 and in the third library 42 can be the same. In particular, therefore, inside the memory 26, for each known compound data can be present of the LRI, of the IR absorption spectrum and of the mass spectrum.

Advantageously, in a possible embodiment, in said at least one processing unit 24, a software module can be loaded and/or executed to coordinate and synchronize the control and processing units 30, 31, 32 and/or 34 of the modules 2 , 3 and 4, and/or to acquire and manage the data deriving and/or representative of the detections, of the chemical compounds contained in the sample S to be analyzed, carried out by means of said three modules 2, 3 and 4.

Conveniently in said control unit and control 24 a software module for processing and analysis can be implemented.

In particular, the processing and analysis software module receives the data acquired by said three modules 2, 3 and 4 and is configured so that—on the basis of the comparison between the data acquired with the data contained in the libraries 40, 41 and 42, relating to a plurality of known and predefined compounds, and contained in memory 26—identifies the chemical compounds contained in sample S.

In particular, said processing and analysis software module is configured to carry out a first comparison 50 between the data 51 of the LRIs, acquired by means of said chromatographic module 2 and relating to the unknown compound present in the sample S to be analyzed, with the data of the retention indices of a plurality of known and predefined compounds.

Conveniently, said processing and analysis software module is configured to identify, on the basis of said first comparison 50 (carried out by means of traditional mathematical/statistical methods of data analysis/comparison) between the data 51 of the LRI, acquired and relating to the compounds contained in the sample S, and the LRI data, relating to a plurality of known compounds and contained in the first library 40, a first group of known compounds 52 having LRI equal to or close to that of the unknown compound contained in the sample S to be analyzed. Conveniently, said first group 52 can comprise one or even more known compounds. Preferably, the known compounds within the first group 52 can be sorted on the basis of the degree of equality/similarity between the corresponding LRI and that of the compound contained in the sample S to be analyzed.

In particular, said processing and analysis software module is configured to carry out a second comparison 53 between the data 54 of the mass spectra, acquired by means of said module 3 for mass spectrometry and relating to the unknown compound present in the sample S to be analyzed, with the mass spectra data of a plurality of known and predefined compounds.

Conveniently, said processing and analysis software module is configured to identify, on the basis of said second comparison 53 (carried out by means of traditional mathematical/statistical methods of analysis/comparison of the data) between the data 54 of the mass spectra, acquired and relating to the compounds contained in sample S, and the data of the mass spectra, relating to a plurality of known compounds and contained in the second library 41, a second group of known compounds 55 having mass spectrum equal to or similar to that of the unknown compound contained in sample S to analyze. Conveniently, said second group 55 can comprise one or even more known compounds. Preferably, the known compounds within the second group 55 can be sorted on the basis of the degree of equality/similarity between the corresponding mass spectrum and that of the compound contained in the sample S to be analyzed.

In particular, said processing and analysis software module is configured to carry out a third comparison 56 between the data 57 of the IR spectra, acquired by means of said module 4 for IR spectroscopy and relating to the unknown compound present in the sample to be analyzed, with the data of the IR spectra of a plurality of known and predefined compounds.

Conveniently, said processing and analysis software module is configured to identify, on the basis of said third comparison 56 (carried out using traditional mathematical/statistical methods of data analysis/comparison) between the data 57 of the IR spectra, acquired and relating to the compounds contained in sample S, and the data of the IR spectra, relating to a plurality of known compounds and contained in the third library 42, a third group of known compounds 58 having the same or similar IR spectrum to that of the unknown compound contained in the sample S to be analyzed. Conveniently, said third group 58 can comprise one or even more known compounds. Preferably, the known compounds within the third group 58 can be sorted on the basis of the degree of equality/similarity between the corresponding IR spectrum and that of the compound contained in the sample S to be analyzed.

In substance, suitably, said processing and analysis software module is configured to identify three groups of known compounds 52, 55 and 58 by means of three respective comparisons 50, 53 and 56—which are advantageously carried out in parallel and simultaneously—of the acquired data 51, 54 and 57 from each module 2, 3 and 4 with the known and predefined (standard) data contained in the three corresponding libraries 40, 41 and 42 loaded into the memory unit 26.

Advantageously, the memory unit 26 with the three libraries 40, 41 and 42 can be provided locally on the processing unit 24 and/or it can be provided remotely and be connected to the processing unit 24 via the Internet.

The processing and analysis software module is also configured so that, on the basis of said three comparisons 50, 53 and 56, it identifies—among the known and predefined compounds—at least one known compound, preferably a single known compound, which is contained in said sample S.

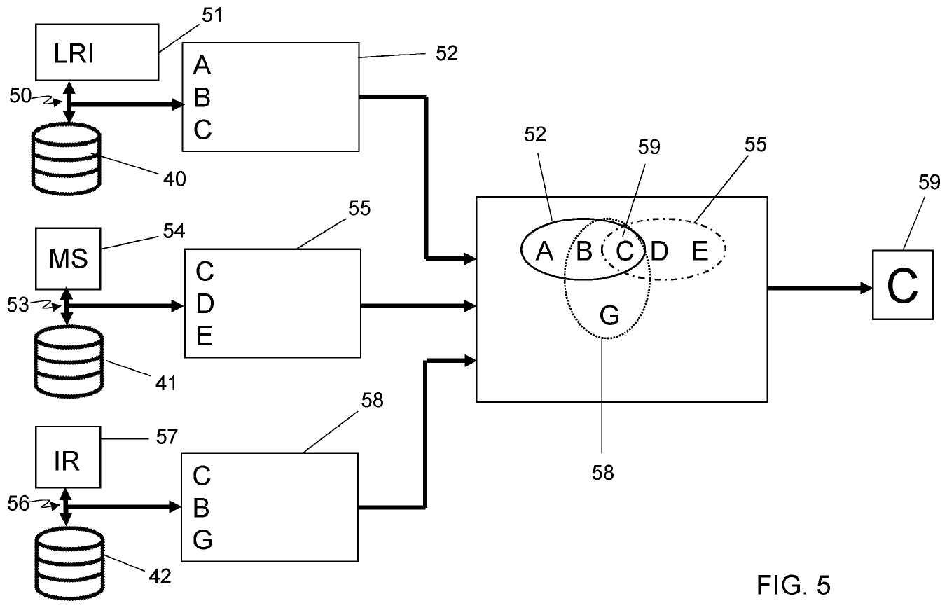

Conveniently (see FIG. 5), the processing and analysis software module is also configured so that, on the basis of the three groups of known compounds 52, 55 and 58 (which have been selected by means of three respective comparisons 50, 53 and 56), selects the known compound or compounds which are present/common in all three said groups, thus defining a subgroup 59 (which substantially corresponds to the intersection of the three groups 52, 55 and 58). Conveniently, the subgroup 59 can comprise only one known compound (if only one compound is present in all three groups) or it can comprise two or more known compounds.

Conveniently, the processing and analysis software module is also configured so that, if the subgroup 59 comprises only one known compound, then the compound contained in the analyzed sample S is identified with (corresponds to) said only known compound present in the subgroup 59.

Conveniently, the processing and analysis software module is also configured so that, if the subgroup 59 includes two or more known compounds (i.e. in the case where two or more known compounds are present in all three groups), to each compound of subgroup 59 a value is associated (which is preferably representative and/or derived from the degree of equality/similarity deriving from the three comparisons 50, 53 and 56) and the compound contained in the analyzed sample S is identified with (corresponds to) the known compound of said subgroup 59 to which the highest value is associated.

Preferably, said value can correspond to the sum or the statistical average or the weighted average of the degrees of equality/similarity that the same known compound had in each of the three groups 52, 55 and 58.

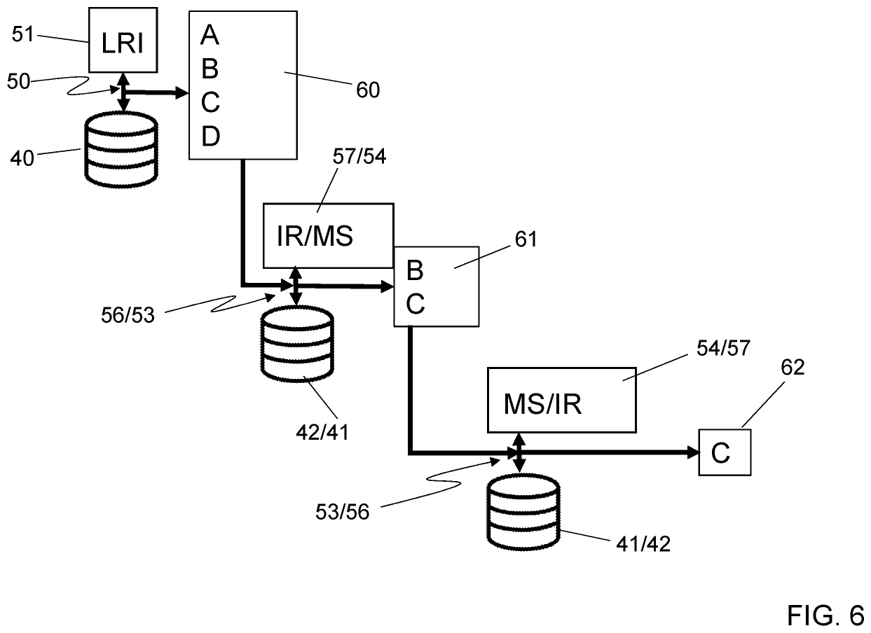

Conveniently, in a further possible embodiment (cfr. FIG. 6), said processing and analysis software module can be configured to carry out the aforementioned three comparisons 50, 53 and 56 in cascade, or in a sequential manner, and in such a way that the subsequent comparison is carried out only between the known compounds that were selected in the previous comparison. In particular, the processing and analysis software module can be configured to carry out said first comparison/filter 50 (for example on the basis of the LRI data) and thus select a group of known compounds 60, then said second comparison/filter 53 is performed (for example on the basis of the mass spectra) or said third comparison/filter 56 (for example on the basis of the IR spectra) only among the compounds of said group 60, to thus select a subgroup of known compounds 61, and finally said third comparison/filter 56 (for example on the basis of the IR spectra) or said second comparison/filter 53 (for example on the basis of mass spectra) only among the compounds of said subgroup 61, to thus identify the known compound 62 of said subgroup 61 which corresponds or is more similar to the compound contained in sample S.

Conveniently, the three comparisons/filters 50, 53 and 56 always use:
the data 51 of the LRIs acquired by means of the chromatographic module 2, comparing them with the data of the LRIs of the known compounds contained in the first library 40,
the data 54 of the mass spectra acquired by the module 3 for mass spectrometry, comparing them with the data of the mass spectra of the known compounds contained in the second library 41,
the data 57 of the IR spectra acquired by means of module 4 for IR spectroscopy, comparing them with the data of the IR spectra of the known compounds contained in the third library 42.

Conveniently, the aforementioned three comparisons/filters 50, 53 and 56 can be carried out simultaneously and/either separately (see FIG. 5) or in sequence (see FIG. 6) and in any order.

Conveniently, for each of the three comparisons/filters 50, 53 and 56, a corresponding degree of minimum equality/similarity can be set for the selection of the known compounds.

Conveniently, the comparison between the acquired data with those of the corresponding library, as well as the definition of the degree of equality/similarity between the acquired data and those of the corresponding library, are carried out by means of known and traditional statistical and/or probabilistic methods.

Advantageously, in a possible embodiment, the processing and analysis module can be trained by means of suitable machine learning methods, to thus allow more precise and/or rapid comparisons to be made between the data acquired by said modules 2, 3 and 4 and the data present in the respective three libraries 40, 41 and 42.

Conveniently, the relative degree of equality/similarity (preferably expressed in percentage terms) between the acquired compound and the known compound identified substantially defines the level of matching (correspondence) between the two compounds, thus defining the level of accuracy of the comparison that led to the identification of a certain known compound. In other words, the higher the relative degree of equality/similarity, the higher the level of matching and therefore the accuracy of the result obtained.

Conveniently, the processing and analysis software module can also be programmed to output a report that can be viewed on the screen—and preferably printable—containing the name of the compound or compounds identified, preferably with the associated degree of equality/similarity with respect to to the known compound (s) and predefined/identified.

Advantageously, said report presents, in an ordered form (preferably according to the relative degree of equality/similarity) and simply consultable, the known compounds identified by each of the three comparisons 50, 53 and 56 carried out respectively on the basis of the LRI, of the mass spectra and of the IR spectra. Conveniently, only compounds with a degree of equality/similarity greater than a value that can be predefined or set by the user can be presented in the report. Preferably, said report can highlight or present only the known compounds common to the three comparisons made.

Conveniently, the processing and analysis module is configured to use three independent analytical information (LRI, IR spectra and mass spectra), interactively and sequentially, obtained simultaneously in the context of a single GC-MS-FTIR or HPLC-MS-FTIR, for the accurate, automated and reliable identification of unknown molecules in complex mixtures.

Conveniently, as mentioned, a first analytical information is obtained by means of the chromatographic module 2 and concerns the linear retention index (LRI) calculated and relative to a homologous series of reference compounds used as standards and analyzed under the same analysis conditions (phase stationary, elution program and all other experimental variables). Conveniently, the calculated LRI value provides information on the retention characteristics of a compound on a specific stationary phase and is determined by the physico-chemical characteristics of the solute, such as molecular geometry, vapor pressure, polarity, hydrophobicity, the molecular weight, etc.

Conveniently, as said, the second analytical information is obtained by means of module 3 and concerns the mass spectrum of the compound and provides information on the molecular formula of the compound and on the ions generated by fragmentation. Conveniently, the set of this information is used for the identification of the compound by searching in spectral libraries, preferably applying a minimum similarity criterion.

Conveniently, as said, the third analytical information is obtained by means of module 4 and relates to the solid phase FTIR spectrum of the compound obtained by direct deposition interface. The FTIR spectrum provides information on the functional groups and the different types of bonds present in a molecule, as well as their arrangement (regiochemistry). Conveniently, this information is used for the identification of the compound by searching in spectral libraries, preferably applying a minimum similarity criterion.

Conveniently, the apparatus 1 according to the invention is configured to use the LRIs as filters to limit the search for MS spectra or IR spectra within the corresponding libraries to a limited portion of analysis, defined as the retention or elution window.

Advantageously, the apparatus according to the invention is configured to implement a method for identifying at least one chemical compound in a mixture, in particular to identify one or more unknown molecules in complex mixtures, said method comprising the sequence of the following steps:
I) the sample (S) to be analyzed is sent to the chromatographic module (2),
II) the chromatographic analysis of a compound or a mixture of compounds contained in the sample (S) is carried out using the chromatographic module 2 and the MS and FTIR spectra of the compound or compounds contained in the sample (5) are acquired, respectively, by means of modules 3 and 4 and separated by said chromatographic module (2);
III) the chromatographic analysis of a homologous series of reference compounds is carried out using the chromatographic module 2, under the same experimental conditions as in point II);
IV) the LRIs of the compound or compounds of the separate mixture to be identified are calculated with respect to those of the homologous series used in point III);
V) MS and FTIR spectra are searched in corresponding databases and at least one candidate is selected on the basis of a minimum similarity criterion.

Conveniently, the LRI value calculated for the compound or compounds to be identified is used as an additional filter for the search in the database of MS and/or FTIR spectra, to thus limit the results of the spectral search to a specific retention window.

Conveniently, the calculation of the LRI of point IV) is performed automatically by software using the equation (4) described above and reported below:

$$L R I = 100 n + 100 \frac{{t}_{Ri} - {t}_{Rn}}{{t}_{R ( n + 1 )} - {t}_{R n}} \qquad Eq . 6$$

Preferably, said retention window is defined by the LRI value, plus or minus a tolerance interval (ΔLRI) suitably set/selected on the basis of the reproducibility of the retention indices.

Conveniently, as the number of spectra contained in the libraries increases, not only the information useful for identifying unknown molecules increases, but also the ability to discriminate between very similar molecules and the ability to provide structural information on unknown molecules, even in the absence of the corresponding spectrum in the library.

### Example 1

The solution according to the present invention has been advantageously used to identify as target molecules volatile organic compounds belonging to the so-called “flavor and fragrance” class and contained in natural samples used above all in the cosmetic field.

In particular, an apparatus was used according to the configuration schematically illustrated in FIG. 1B where:
the chromatographic module 2 included a capillary GC column of the following dimensions: 30 m L×0.25 mm id×0.25 m df, with bound stationary phase consisting of a silphenylene polymer (virtually equivalent in polarity to a stationary phase based on 5% diphenyl/95% dimethylsiloxane).
the separation of the components of the analyzed samples was obtained under the following experimental conditions: injector temperature, 280° C.; carrier gas (helium) at a constant linear speed of 30 cm/s; programmed temperature, 50-350° C. at 3° C./min, followed by isotherm at 350° C. for 5 min.
The terminal end of the GC column has been connected to a three-way flow splitting device and constitutes the input branch to said splitting device.
the first branch leaving the splitting device 10 is constituted by a capillary of deactivated fused silica having dimensions of 1.2 m L×0.10 mm id connected to the module 3 for mass spectrometry. In particular, the mass spectra were obtained with a single quadrupole mass spectrometer equipped with an EI source, with the following instrumental parameters: source temperature, 250° C.; interface temperature, 200° C.; acquisition range, uma; energy, 70 eV.
the second branch coming out of the splitting device 10 is constituted by a capillary of deactivated fused silica of dimensions 1.8 m L×0.20 mm id connected to module 4 for IR spectroscopy, in particular FTIR, by means of a transfer interface 80 heated and maintained at a temperature of 280° C. In particular, the solid phase FTIR spectra were obtained with a spectrophotometer equipped with an MCT (mercury-cadmium-tellurium) detector, by direct deposition (DD) of the eluted compounds from the GC column on a cooled zinc selenide disc. at −90° C. by liquid nitrogen, with the following instrumental parameters: spectral range of acquisition, 650-4000 cm⁻¹; scan rate, 2 Hz; resolution, 4 cm⁻¹; disc rotation speed, 3 mm/min.
   For the calculation of the retention indices, a standard mixture of was used as homologous series n-paraffins consisting of 24 compounds with increasing number of carbon atoms, starting from n-heptane (C7) up to n-triacontane (C30). The retention times of the compounds of this homologous series fully covered the elution range of the compounds in the analyzed samples.

To search the database of the mass spectra of the compounds to be identified, a commercial library (FFNSC 4.0) was used, containing the GC-MS spectra of known compounds of the flavor and fragrance series, accompanied by the LRI values calculated for said compounds. The latter were obtained by analysis on three stationary phases with different polarity and calculated with reference to three different homologous series (n-paraffins, methyl esters of fatty acids, ethyl esters of fatty acids). For the database search of the FTIR spectra of the compounds to be identified, a specially constructed library (FFNSC GC-FTIR.lib) was used, containing the solid phase GC-FTIR spectra of known compounds of the flavor and fragrance series, accompanied by the values of LRI calculated for said compounds. The latter were obtained by analysis on three stationary phases with different polarity and calculated with reference to three different homologous series (n-paraffins, methyl esters of fatty acids, ethyl esters of fatty acids).

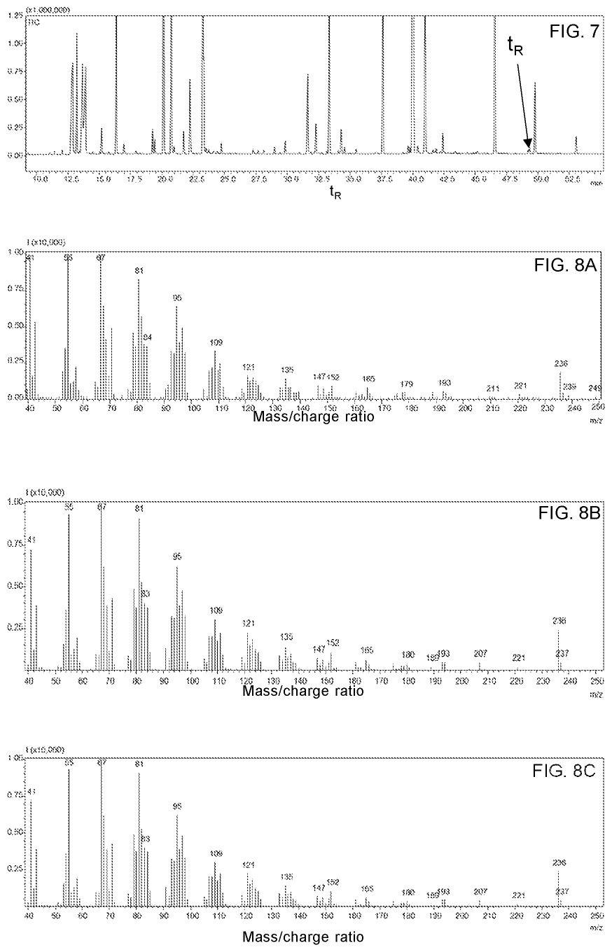

In particular, the apparatus object of the invention and as described above was used for the identification of the compound (E)-cyclohexadec-5-enone (CAS 35951-24-7), commonly known as trans-Toray musk, in a commercial perfume sample. Under the experimental conditions adopted, the compound elutes at a retention time tR of 49.226 min, as per the chromatogram shown in FIG. 7. The experimental LRI value calculated for the peak with respect to the homologous series mentioned above is equal to 1915. The search in the database of the EI-MS spectrum of the unknown compound, shown in FIG. 8A, applying as a filter a minimum similarity criterion≥90%, produced a list of five possible candidates, as reported in Table 1 below, also having different molecular formulas.

TABLE 1

| | Simi- | | Molecular | | |
|---|---|---|---|---|---|
| HIT | larity | Compound | Weight | Formula | Library |
| 1 | 96 | (Z)-cyclohexadec- | 236 | C₁₆H₂₈O | FFNSC |
| | | 5-enone | | | 4.0.lib |
| 2 | 96 | (E)-cyclohexadec- | 236 | C₁₆H₂₈O | FFNSC |
| | | 5-enone | | | 4.0.lib |
| 3 | 92 | (E)-cycloheptadec- | 250 | C₁₇H₃₀O | FFNSC |
| | | 9-enone | | | 4.0.lib |
| 4 | 92 | (Z)-cycloheptadec- | 250 | C₁₇H₃₀O | FFNSC |
| | | 9-enone | | | 4.0.lib |
| 5 | 90 | (E)-cyclopentadec- | 222 | C₁₅H₂₆O | FFNSC |
| | | 4-enone | | | 4.0.lib |

The results of Table 1 show how, even using a very high exclusion threshold, the data of the mass spectra are not sufficient for the identification of the compound under examination. In particular, the two compounds listed as hit number 1 and hit number 2 both have a very high similarity score, equal to 96, and are in fact stereoisomers: (Z)-cyclohexadec-5-enone and (E)-cyclohexadec-5—and it is not. Indeed, the EI-MS spectra recorded in the library show that the two cis- (see FIG. 8B) and trans- (see FIG. 8C) isomers, in addition to having identical molecular masses, undergo the same fragmentation mechanism; therefore the EI-MS spectra are indistinguishable, by type of m/z ions and relative intensity. Subsequently, an additional filter represented by the LRI values was then applied, in particular using a tolerance of ±5 LRI with respect to the calculated experimental value (1915). In this way the list of possible candidates is restricted to those compounds having a minimum similarity≥90% and an LRI value between 1910 and 1920. The number of possible candidates has therefore decreased to two, in particular trans-Toray musk (ΔLRI=1) and cis-Toray musk (ΔLRI=2), both with molecular formula C₁₆H₂₈O. The results show that the application of a very narrow tolerance window, made possible by the high reproducibility of the LRI values under the experimental conditions adopted, does not allow the identification of the unknown compound.

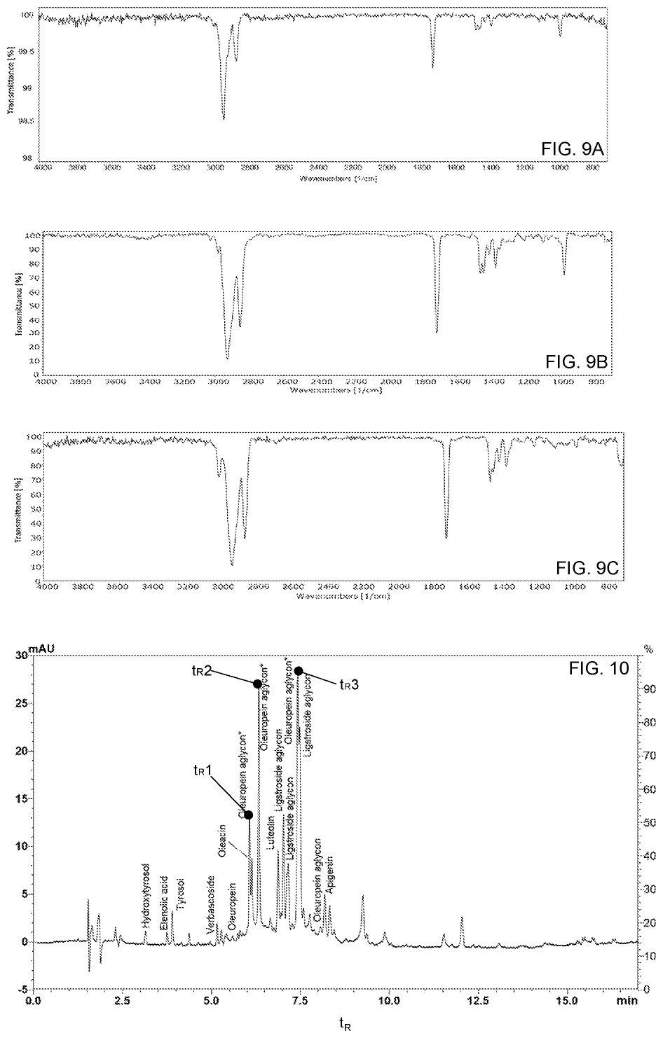

Finally, the database search of the solid phase FTIR spectrum of the unknown compound, shown in FIG. 9A, allowed to identify the compound with a high degree of certainty. In fact, by applying a minimum similarity criterion 90%, a single candidate is obtained, (E)-cyclohexadec-5-enone, commonly known as trans-Toray musk.

The reliability and accuracy of the identification are confirmed in the first place by the high spectral similarity score obtained by the research, equal to 98.45%, but also by the high differential between hit number 1, corresponding to the compound target, and the hit number 2, corresponding to theisomer cis-Toray musk ((E)-cyclohexadec-5-enone), for which the similarity score was equal to 75.56%. Conveniently, therefore, the FTIR technique employed, by measuring small energy differences of the rotational and vibrational motions between the different molecular bonds, has allowed to overcome the intrinsic limitations of MS detection, for the discrimination of the two diastereomeric compounds.

### Example 2

The solution according to the present invention has been advantageously used to identify as target molecules non-volatile organic compounds belonging to the polyphenol family and contained in natural samples used above all in the food sector. In particular, an apparatus was used according to the configuration schematically illustrated in FIG. 1C where:
the chromatographic module 2 comprised a packed HPLC column with the following dimensions: 15 cm L×4.6 mm id×2.7 μm dp, with stationary phase bound to octadecylsilic base (ODS or C18).
the separation of the components of the analyzed samples was obtained under the following experimental conditions: mobile phase, water with 0.1% formic acid (solvent A) and acetonitrile with 0.1% formic acid (solvent B); flow rate of the mobile phase, 1.0 mL/min; gradient, 0 min 10% B, 4 min 35% B, 12 min 47% B, 12.5 min 60% B, 16 min 75% B, 21 min 100% B; oven temperature, 30° C.; injection volume, 5 μL.
the terminal end of the LC column was connected to a three-way flow splitter 10.
the first branch leaving the splitting device 10 consisted of a tube with a reduced internal diameter connected to the module 3 for mass spectrometry. The mass spectra were obtained with a single quadrupole mass spectrometer equipped with an ESI source, with the following instrumental parameters: temperature of the desolvation line, 280° C.; temperature of the heat block, 300° C.; atomization gas flow (nitrogen), 1.5 mL/min; flow of drying gas, 5 L/min; acquisition range, 100-800 uma.
the second branch coming out of the splitting device 10 consisted of a tube with a diameter equal to the first but with a length equal to a third, connected to the module 4 for IR spectroscopy, in particular FTIR by means of an interface 12 for the evaporation of the solvent. The solid phase FTIR spectra were obtained with a spectrophotometer equipped with an MCT (mercury-cadmium-tellurium) type detector, by direct deposition (DD) of the eluted compounds from the LC column, after evaporation of the solvent in the interface, on a disk of zinc selenide, cooled to +10° C. by liquid nitrogen, with the following instrumental parameters: spectral range of acquisition, 650-4000 cm⁻¹ ; scan rate, 2 Hz; resolution, 4 cm⁻¹ ; disc rotation speed, 3 mm/min. The interface parameters were: nebulizer voltage, 16 W; cyclone temperature, 180° C.; condenser temperature, +4° C.

For the calculation of the retention indices, a standard mixture of carboxylic acids consisting of 4 compounds with an increasing odd number of carbon atoms (from 3 to 9), from propionic acid to nonanoic acid, was used as a homologous series. The retention times of the compounds of this homologous series fully covered the elution range of the compounds in the analyzed samples.

In particular, the apparatus object of the invention and as described above was used for the identification of the isomers of a polyphenolic compound, known as oleuropein, ubiquitous in olive oil samples, for which they are reported in literature numerous molecules generically identified as “oleuropein aglycone”. A typical analysis of this sample is shown in the chromatogram in FIG. 10. The analysis of the ESI-MS data and the comparison with the literature data allowed the assignment of three peaks, among those with greater intensity, as oleuropein aglycone (marked with t_{R}1, t_{R}2 and _{R}3), with molecular formula C₂₅H₃₂O₁₃ and average molecular mass 378.

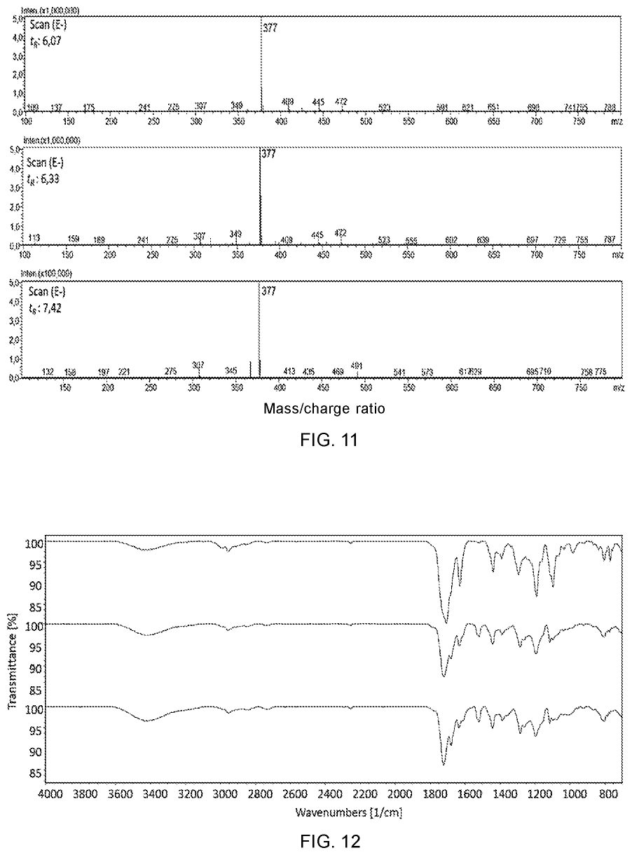

The three corresponding spectra obtained in ESI-MS are identical, as shown in FIG. 11, and in particular characterized by the presence of a single signal corresponding to the deprotonated molecular ion ([MH]⁻). The experimental LRI values calculated for the three peaks with respect to the homologous series mentioned above were: 504 (for compound 1 with retention time t_{R}1 equal to 6.07 min), 514 (for compound 2 with retention time t_{R}2 equal to 6.33 min), 560 (for compound 3 with retention time t_{R}3 equal to 7.42 min). On the basis of these data, taking into account that in HPLC the variability of the LRI is significantly greater than in the GC counterpart, therefore the tolerance typically adopted for the research is on average in the range between ±15 and ±20 LRI compared to the calculated experimental value, it is evident how this filter would exclude compound 3 from the research, but would not allow discrimination between compounds 1 and 2.

Finally, the FTIR spectra obtained for the three solid phase molecules are shown in FIG. 12 (compounds 1, 2 and 3, from top to bottom). Apart from the obvious differences in the so-called “fingerprint” region at lower wave numbers, in particular for compounds 1 and 2, marked differences in the range between 1800-1600 cm⁻1 are appreciated, such as even around 1200 cm⁻¹. On the basis of these distinctive characteristics of the FTIR spectra, the library search of unknown compounds allows the univocal discrimination between the three isomers of oleuropein aglycone.

### Example 3

The solution according to the present invention was advantageously used to discriminate molecules very similar to each other and, in particular, it was used to identify a molecule belonging to the class of synthetic cannabinoids (subsequently identified as JWH-250), in a seized sample of drug of abuse, analyzed by the apparatus according to the invention in the configuration used for example no. 1.

The spectral library search of EI-MS data, the results of which are illustrated in Table 2, below, applying a very stringent exclusion criterion (minimum similarity 90%) returns a list of 10 possible candidates for the identification of the unknown molecule.

TABLE 2

| | Similarity | | Molecular | | |
|---|---|---|---|---|---|
| Hit | MS | Compound | Weight | Formula | Library |
| 1 | 96 | JWH-250 | 335 | C₂₂H₂₅NO₂ | SWGDRUG_3.6.lib |
| 2 | 94 | JWH-302 | 335 | C₂₂H₂₅NO₂ | SWGDRUG_3.6.lib |
| 3 | 94 | JWH-201 | 335 | C₂₂H₂₅NO₂ | SWGDRUG_3.6.lib |
| 4 | 91 | JWH-167 | 305 | C₂₁H₂₃NO | SWGDRUG_3.6.lib |
| 5 | 91 | JWH-251 3- | 319 | C₂₂H₂₅NO | SWGDRUG_3.6.lib |
| | | methylphenyl | | | |
| | | isomer | | | |
| 6 | 90 | JWH -208 | 319 | C₂₂H₂₅NO | SWGDRUG_3.6.lib |
| 7 | 90 | JWH-206 | 339 | C₂₁H₂₂ClNO | SWGDRUG_3.6.lib |
| 8 | 90 | JWH-8237 | 339 | C₂₁H₂₂ClNO | SWGDRUG_3.6.lib |
| 9 | 90 | PB-22 | 358 | C₂₃H₂₂N₂O₂ | SWGDRUG_3.6.lib |
| 10 | 90 | JWH-251 | 319 | C₂₂H₂₅NO | SWGDRUG_3.6.lib |

Some of these molecules have different molecular weights, but evidently a very similar fragmentation pathway. In particular, hits 1, 2 and 3, with minimum similarity 94%, correspond to three isobar molecules, having the same molecular formula (C₂₂H₂₅O₂). The three regioisomers have identical molecular mass and very similar EI-MS spectra: 1-(1-pentyl-1H-indol-3-yl)-2-(2-methoxyphenyl)-ethanone (JWH-250), 2-(3-methoxyphenyl)-1-(1-pentyl-1H-indol-3-yl)-ethanone (JWH-302), 2-(4-methoxyphenyl) -1-(1-pentyl-1H-indol-3-yl)-ethanone (JWH-201). Evidently, in the absence of the corresponding spectrum in the EI-MS library, and even applying a very stringent minimum similarity filter, the unknown molecule would have been erroneously identified as JWH-302 or JWH-201 (both with spectral similarity equal to 94%), or even as one of the subsequent hits.

### Example 4

The solution according to the present invention was advantageously used in order to provide structural information on unknown molecules, even in the absence of the corresponding spectrum in the library, and, in particular, it was used for the identification of a generic molecule belonging to to the class of butyric acid esters. In particular, the “hexyl butyrate” molecule was identified, in the absence of the corresponding MS and FTIR spectra in the library, for which an experimental LRI value equal to 1195 was calculated. The search in the FTIR spectral library provided the results shown in Table 3, which shows that the hits with the highest score, from 1 to 7 (and subsequent ones not reported for convenience), all correspond to molecules belonging to the family of butyric acid esters.

TABLE 3

| | Simi- | | | |
|---|---|---|---|---|
| | larity | | | |
| Hit | FTIR | Compound | LRI | Library |
| 1 | 96.62 | Butyrate <heptyl> | 1293 | FFNSC_GC-FTIR.lib |
| 2 | 95.49 | Butyrate <pentyl> | 1095 | FFNSC_GC-FTIR.lib |
| 3 | 91.89 | Butyrate <butyl> | 999 | FFNSC_GC-FTIR.lib |
| 4 | 88.52 | Butyrate <isopentyl> | 1054 | FFNSC_GC-FTIR.lib |
| 5 | 87.68 | Butyrate <pentylallyl> | 1282 | FFNSC_GC-FTIR.lib |
| 6 | 85.98 | Butyrate <3,7- | 1529 | FFNSC_GC-FTIR.lib |
| | | dymethyloct-6-enyl> | | |
| 7 | 85.90 | Butyrate <2-methylbutyl> | 1104 | FFNSC_GC-FTIR.lib |

Even in the absence of the corresponding spectrum in the library, the FTIR data still provided information relating to the chemical class to which the molecule belongs, information which, on the other hand, is not obtainable from the mass spectra, as these molecules evidently differ from each other in length. of the alkyl chain, so they will have different molecular formulas and molecular weights. Moreover, it is also foreseeable that the search in a mass library of an experimental spectrum of a molecule with a given molecular mass will give results corresponding to compounds with very different chemical structures. Conversely, we can speak for the FTIR technique of “family-type” identification. Even research based on LRIs is able to provide useful information for identification, in the absence of the standard in the library: in fact, again from the results in Table 3 it is clear that the experimental value of LRI calculated for the unknown molecule, equal to 1195, is it places exactly between that of the “heptyl butyrate” molecule, equal to 1293, and that of the “pentyl butyrate” molecule, equal to 1095, both with similarity of the FTIR spectra greater than 91%. It can therefore be rationally assumed that, on the basis of the structural characteristics (length of the alkyl chain) and therefore of the consequent retention characteristics under the conditions adopted, this unknown molecule corresponds to “hexyl butyrate”.

As is clear from what has been described, the apparatus according to the invention is particularly advantageous in that:
allows to recognize/identify precisely and accurately which chemical compounds are contained within a mixture,
provides compound identification with an accuracy level greater than 90% and, advantageously, even greater than 99%,
allows to carry out three analyzes in a simple, rapid and complete way, on an unknown sample, thus increasing the probability of correctly identifying the compounds contained in said sample,
is highly integrated,
is fully automated both in data acquisition and in their processing and evaluation/interpretation,
is quick and easy to use, and
it does not require any intervention on the part of the user, thus allowing greater safety for the user as well as evaluations independent of the manual skill and experience of the latter.

Advantageously, the apparatus according to the invention can be used for the analysis of foods, for the analysis of drugs and narcotic substances, for the analysis of aromas and fragrances, for the analysis of pesticides, for the analysis of fatty acids and in other applications.

The present invention has been illustrated and described in some of its preferred embodiments, but it is understood that executive variations may apply thereto in practice, without however departing from the scope of protection of the present patent for industrial invention.

1. Apparatus (1) for chemical analysis of a sample (S), to identify at least one chemical compound contained in a mixture in a sample (S) to be analyzed, the apparatus comprising:
a chromatographic module (2), which is configured to separate the compounds that make up said mixture to be analyzed and which is configured to determine linear retention indices (LRI) of the compounds, thus separated, of said sample (S),
a module (3) for mass spectrometry, which is configured to at least one of detect or determine mass spectra of the compounds which come out, separately from each other, from said chromatographic module (2),
a module (4) for infrared IR spectroscopy, which is configured to at least one of detect or determine infrared IR spectra of the compounds that come out, separately from each other, from said chromatographic module (2),
at least one processing unit (24) that is configured to receive:
data, acquired by means of said chromatographic module (2), of the linear retention indices (LRI) of said compounds,
data, acquired by means of said module (3) for mass spectrometry, of the mass spectra of said compounds,
data, acquired by means of said module (4) for IR spectroscopy, of the IR spectra of said compounds,
at least one memory unit (26), which is at least one of connected to or incorporated in said at least one processing unit (24), and in which at least one organized file containing the retention indices, the mass spectra and the IR spectra of a plurality of known and predefined compounds is stored,
wherein in said at least one processing unit (24) a processing and analysis software module is at least one of loaded or executed which is configured to:
carry out a first comparison (50) between the linear retention indices (LRI) of at least one compound contained in said sample (S) with the LRIs linear retention indices (LRI) of said plurality of known and predefined compounds,
carry out a second comparison (53) of the mass spectra of at least one compound contained in said sample (S) with the mass spectra of said plurality of known and predefined compounds,
carry out a third comparison (56) between the IR spectra of at least one compound contained in said sample (S) with the IR spectra of said plurality of known and predefined compounds,
identify, on the basis of said three comparisons (50, 53, 56), at least one compound, among the known and predefined compounds, which corresponds to said at least one compound contained in said sample (S)
and wherein:
the module (3) for mass spectrometry and the module (4) for IR spectroscopy are fluidically connected, in parallel with each other, with an output of the chromatographic module (2) so that the flow of the compounds that exit separately from said chromatographic module (2), is subdivided/split between the module (3) for mass spectrometry and the module (4) for IR spectroscopy.

2. The apparatus according to claim 1, wherein said module (4) for IR spectroscopy is a direct deposition type.

3. The apparatus according to claim 1, wherein said module (4) for IR spectroscopy comprises a rotating support for the deposition of an analyte in the solid phase, said rotating support being, at least in a part thereof, transparent to radiation IR.

4. The apparatus according to claim 1, wherein said module (4) for IR spectroscopy comprises a support on which the sample (S), which is cooled to a temperature higher than 100 K, is intended to be condensed.

5. (canceled)

6. The apparatus according to claim 1, wherein said chromatographic module (2) comprises at least one of the following devices:
a gas chromatographic (GC) device,
at least one of a liquid chromatography (LC) device or a high performance liquid chromatography (HPLC) device,
a thin layer chromatography (TLC) device,
a device for supercritical (SFC) or subcritical (sub-SFC) fluid chromatography.

7. The apparatus according to claim 1, further comprising at least one transfer interface (80), comprising at least one transfer line (81, 82, 83), which is configured to transport the compounds separated from said chromatographic module (2) in input to said module (4) for infrared (IR) spectroscopy and to said module (3) for mass spectrometry.

8. The apparatus according to claim 7, wherein said at least one transfer line (81, 82, 83) comprises a tube or capillary duct (9) made of chemically inert material, of deactivated fused silica, or of polymeric material, or of steel.

9. The apparatus according to claim 7, wherein said at least one transfer line (81, 82, 82) comprises a tube or capillary duct (9) for the passage of said compounds and an external containment casing (20) of said tube or capillary.

10. The apparatus according to claim 7, wherein said at least one transfer line (81, 82, 82) comprises temperature control means configured to keep the temperature of the capillary duct (9) constant along its longitudinal development.

11. The apparatus according to claim 1, further comprising, downstream of the chromatographic module (2), a splitting device (10) for the subdivision of the outgoing flow from the chromatographic module (2) between said module for mass spectrometry (3) and said module for IR spectroscopy (4).

12. The apparatus according to claim 7, wherein said at least one transfer interface (80) comprises:
a first transfer line (81), fluidically connecting the chromatographic module (2) with a splitting device (10),
a second transfer line (82), fluidically connecting the splitting device (10) with the module (3) for mass spectrometry,
a third transfer line (83), fluidically connecting the splitting device (10) with the module (4) for IR spectroscopy.

13. The apparatus according to claim 1, further comprising a transfer line (82) fluidically connected to the inlet of the mass spectrometry module (3) and a transfer line (83) fluidically connected to the inlet of the module (4) for IR spectroscopy, said transfer lines having at least one of an internal diameter or length different from each other and defined in such a way that the flow entering said module (4) for IR spectroscopy is greater than the flow entering said module for mass spectrometry (3).

14. The apparatus according to claim 1, wherein:
said chromatographic module (2) comprises a first and dedicated control unit (30) which controls, coordinates and manages the operation of the chromatographic module (2),
said mass spectrometry module (3) comprises a second and dedicated control unit (31) which controls, coordinates and manages the operation of said mass spectrometry module (3),
said module for IR spectroscopy (4) comprises a third and dedicated control unit (32) which controls, coordinates and manages the operation of said module for IR spectroscopy (4)
and wherein:
said first (30), said second (31) and said third (32) control units are electronically connected to each other to thus allow the exchange of command, status and/or synchronization signals,
said first (30), said second (31) and said third (32) control units are electronically connected directly with said at least one processing unit (24).

15. The apparatus according to claim 1, wherein:
said chromatographic module (2) comprises a first and dedicated control unit (30) which controls, coordinates and manages the operation of the chromatographic module (2),
said mass spectrometry module (3) comprises a second and dedicated control unit (31) which controls, coordinates and manages the operation of said mass spectrometry module (3),
said module for IR spectroscopy (4) comprises a third and dedicated control unit (32) which controls, coordinates and manages the operation of said module for IR spectroscopy (4)
and wherein:
said first (30), said second (31) and said third (32) control units are electronically connected to each other to allow the exchange of command, status and/or synchronization signals,
said first (30), said second (31) and said third (32) control units are electronically connected by means of a further processing unit (25), with said at least one processing unit (24).

16. The apparatus according to claim 1, wherein:
at least one of said chromatographic module (2), said module (3) for mass spectrometry or said module for IR spectroscopy (4) comprise a shared control unit (34) which controls, coordinates and manages the operation of at least one of the chromatographic module (2), the module (3) for mass spectrometry or the module for IR spectroscopy (4),
said shared control unit (34) is electronically connected with said processing unit (24).

17. The apparatus according to claim 16, wherein at least one of said first control unit (30), said second control unit (31), said third control unit (32) or said shared control unit (34) are configured to at least one of acquire or calculate the data detected respectively by the chromatographic module (2), by the module (3) for mass spectrometry and/or by the module for IR spectroscopy (4).

18. The apparatus according to claim 1, wherein said processing and analysis software module at least one of loaded or executed in said at least one processing unit (24) is configured:
to carry out said three comparisons (50, 53, 56) so as to select a first group (52) of known compounds among all the known and predefined compounds present in the organized archive loaded in the memory unit (26), respectively second group (55) of known compounds and a third group (58) of known compounds,
to define a subgroup (59) of at least one known compound by selecting the known compound or compounds which are present/common in all three said groups (52, 55, 58),
to identify the compound which is contained in said sample (S) with at least one compound of said subgroup (59), specifically with a compound which is therefore present/common in all three selected groups.

19. The apparatus according to claim 1, wherein said processing unit (24) is configured to carry out said first comparison (50) of the linear retention indices (LRI) as a filter during at least one of said second comparison (53) of the mass or during said third comparison (56) of the IR spectra.

20. The apparatus according to claim 1, wherein said first comparison (50) is configured to identify a first group of known compounds (52) having linear retention indices (LRI) equal to or close to that of the unknown compound contained in the sample LSI to be analyzed, and at least one of said second (53) or said third comparison (56) are carried out on a respective second and third subgroup of known compounds which include only the known compounds of said first subgroup.

21. (canceled)

22. The apparatus according to 1, wherein said processing and analysis software module, at least one of loaded or executed in said at least one processing unit (24), is configured so that said three comparisons (50, 53, 56) are carried out sequentially, so that the subsequent comparison is made only between the known compounds that were selected in the previous comparison.
